(19) United States
(12) Patent Application Publication
(10) Pub. No.: US 2014/0313574 A1
(43) Pub. Date: Oct. 23, 2014

(54) NANOPARTICLE FILMS FOR USE AS SOLAR CELL BACK REFLECTORS AND OTHER APPLICATIONS

(71) Applicants: Braden Bills, Sioux Falls, SD (US); Nathan Morris, Luverne, MN (US); Qi Hua Fan, Ann Arbor, MI (US); Mukul Dubey, Brookings, SD (US); David Galipeau, Brookings, SD (US)

(72) Inventors: Braden Bills, Sioux Falls, SD (US); Nathan Morris, Luverne, MN (US); Qi Hua Fan, Ann Arbor, MI (US); Mukul Dubey, Brookings, SD (US); David Galipeau, Brookings, SD (US)

(73) Assignee: SOUTH DAKOTA STATE UNIVERSITY, Brookings, SD (US)

(21) Appl. No.: 14/155,337

(22) Filed: Jan. 14, 2014

Related U.S. Application Data
(60) Provisional application No. 61/752,033, filed on Jan. 14, 2013.
(60) Provisional application No. 61/876,374, filed on Sep. 11, 2013.

(51) Int. Cl. G02B 5/02; C25D 7/08; B29C 67/20; B05D 3/02; B05D 1/00; B05D 1/02; B05D 1/30; B05D 1/28; C25D 13/02; B05D 1/18

(52) U.S. Cl. CPC G02B 5/0284; C25D 13/02; C25D 7/08; B29C 67/20; B05D 1/18; B05D 1/005; B05D 1/02; B05D 1/305; B05D 1/28; B05D 3/0254; Y10S 977/834; B82Y 20/00
USPC 359/359; 359/350; 204/507; 204/489; 205/109; 264/413; 427/457; 427/430.1; 427/240; 427/427.4; 427/420; 427/428.01; 427/256; 427/385.5; 427/515; 427/510; 427/512; 977/834; 977/774; 977/779; 977/892

(57) ABSTRACT

Disclosed are methods for forming nanoparticle films using electrophoretic deposition. The methods comprise exposing a substrate to a solution, the solution comprising substantially dispersed nanoparticles, an organic solvent, and a polymer characterized by a backbone comprising Si—O groups. The methods further comprise applying an electric field to the solution, whereby a nanoparticle film is deposited on the substrate. Suitable polymers include polysiloxanes, polysilsesquioxanes and polysilicates. Coated glass windows and methods of forming the coated glass windows using the solutions are also disclosed. The methods may be adapted to form nanoparticle films suitable for use as back reflectors in solar cells, where such nanoparticle-based back reflectors exhibit high reflection and light scattering properties, including use of such back reflectors to fabricate solar cells and other photovoltaic-based and light dependent devices such as television screens, computer monitors, portable systems such as mobile phones, handheld games consoles and PDAs.

### CROSS REFERENCE TO RELATED APPLICATIONS

This application claims benefit under 35 U.S.C. §119(e) to U.S. Provisional Application No. 61/752,033, filed Jan. 14, 2013, and 61/876,374, filed Sep. 11, 2013, each of which is incorporated by reference herein in their entireties.

### REFERENCE TO GOVERNMENT RIGHTS

This invention was made with government support under 0903685 and 0903804 awarded by the National Science Foundation. The government has certain rights in the invention.

### BACKGROUND OF THE INVENTION

1. Field of Invention

The present invention relates generally to nanotechnology, and specifically to nanoparticle-film coating of substrates such as glass to provide low emissivity coatings and other surfaces to produce back reflectors, where the latter may be used in photovoltaic energy generation as a component for a solar cell that exhibits high reflection and light scattering properties.

2. Background Information

Emerging research in nanotechnology has led to the development of nanomaterials such as nanoparticles, nanotubes, nanofibers and other structures. The applications of these nanostructured materials for certain devices require deposition of these materials as a thin film onto a substrate. Device performance largely depends on the quality of the deposited thin film such as its uniformity, adhesion to an underlying substrate and thickness. Various processes have been explored to obtain thin films of nanomaterials such as sol-gel, electrochemical deposition, electrophoretic deposition and vacuum based growth techniques.

Back reflector layers are used in some thin film solar cells in order to increase light absorption and photocurrent, thereby improving conversion efficiency of the solar cell. Conventional back reflectors are formed of sputtered metal films, typically via high-vacuum processing techniques such as physical vapor deposition (PVD) and plasma enhanced chemical vapor deposition (PECVD).

Silver films have been coated onto glass windows in order to provide low emissivity coatings. The silver films are typically coated onto the glass windows using high-vacuum vapor deposition methods.

Thin film silicon (Si) solar cells are very attractive photovoltaic devices for energy conversion due to the abundance of Si feedstock, non-toxicity, low susceptibility to moisture leading to fewer encapsulation challenges, and substantial synergies with the flat panel display market. In addition, compared to conventional Si wafer based photovoltaics, thin film Si solar cells have strong low-cost potential as they use significantly less of the expensive Si absorber material (100's nm vs. 100's microns, or 3 orders of magnitude), can be fabricated into large areas, and utilize roll-to-roll manufacturing techniques. However, thin film Si solar cells traditionally have lower efficiencies than their wafer-based Si counterparts, which is partially due to inadequate light absorption by the thin Si layer.

The main absorber of thin film Si solar cell is the intrinsic Si layer (˜300 nm thick) that is responsible for absorbing light to generate charge carriers (electron-hole pairs). A built-in electrical field established by the p-type and n-type Si doping layers (˜0.12 nm thick each) separates the charge carriers and drives them to the electrodes. From a charge collection and materials saving point of view, the intrinsic Si layer needs to be as thin as possible to ensure a strong built-in electrical field. On the other hand, the Si layer may not be able to sufficiently absorb sunlight once it becomes too thin. This is especially true for long wavelength components of the solar spectrum (red light), to which Si has relatively weak absorption. To realize an electrically “thin” and optically “thick” device structure, a highly reflective and light scattering back reflecting layer is desired in order to scatter the light back into the Si layer and hence increase light path and absorption.

Scattered light is reflected at a wider angle to normal which promotes light trapping within the solar absorber material: i.e., reflected light can once again be reflected at the absorber/transparent front electrode interface back into the absorber for a third chance of being absorbed.

Conventional back reflectors consist of silver (Ag) or aluminum (Al) films, which present high reflectance in the full spectrum range of sunlight. Compared to Ag, Al exhibits lower reflectance in long wavelength range from 600 nm to 900 nm due to intrinsic absorption. This part of sunlight actually accounts for the most critical portion that needs absorption enhancement. As a result, Al back reflector leads to about 19% lower photocurrent and efficiency than Ag.

Record high efficiencies of thin film Si solar cells were all achieved using Ag back reflectors. Despite its excellent reflectance, Ag film is not used in thin film Si products, as it is not able to meet the product reliability criteria for three main reasons in addition to cost: (1) Ag has a high mobility. It tends to migrate through the voids in the ZnO buffer layer, which is usually deposited by sputtering at moderate temperatures of −23° C. and is not dense enough, while the subsequent thin film Si process (˜270° C.) further promotes such diffusion. Once Ag reaches the Si absorber layer, it deteriorates the solar cell performance. (2) Ag has low resistance to oxidation. Oxidized Ag becomes dark and loses its reflectivity. The problem starts most commonly from the edge of Ag film and advances laterally to the whole coating layer even though it is covered by a ZnO layer. As solar panels require a long lifetime (>15 years), the conventionally processed Ag thin film back reflectors are not able to pass standard reliability tests, such as IEC 61215 and 61646. In fact, the oxidation issue of Ag films has been a long-standing problem in low-emission glass coatings for buildings windows and in flat panel display devices. (3) Ag thin films usually exhibit poor adhesion to most substrate materials, like stainless steel, plastic, and glass. This eventually leads to device failure.

Al thin films do not experience the longevity problems that Ag films do, so despite the efficiency tradeoff, it is actually Al, not Ag, being used as back reflector material in most commercially available solar panel products.

Further, metal based back reflector and buffer layer are deposited by high-vacuum sputtering process, which is time consuming, energy intensive, and has high material cost and waste. Moreover, with metal sputtered back reflectors diffuse reflection is much less than total reflection signifying weak light scattering.

Thin film photovoltaic technologies also face major challenges due to the scarcity of key elements. For example, tellurium used in cadmium telluride (CdTe) cells and indium used in copper indium gallium selenide (CIGS) cells are in low abundance in the Earth's crust and are usually obtained as a by-product when mining and refining copper and zinc. Indium is also heavily used in the flat panel display and touch screen industries, contributing to its high demand. By decreasing the absorber material thickness and thus increasing the efficiency, the amount of material used can be substantially reduced.

Therefore, to improve performance and cost competitiveness of commercial thin film Si solar cell products, alternative back reflector materials that have equal or greater broadband reflectance as Ag without the long term performance and reliability problems are needed as well as atmospheric deposition methods.

An important non-sputtered metal type of back reflector is pigmented diffuse back reflectors which have enhanced light trapping properties due to Lorenz-Mie light scattering. Light trapping can be accomplished with conventional sputtered metal based back reflectors by depositing absorber on textured surface or by anisotropic etching of the absorber surface, but deposition of high quality absorber films with large grain size is challenging on rough surfaces and etching of absorber can deteriorate performance and is costly since absorber thickness is significantly reduced and can require lithography.

Examples of additive light trapping back reflectors include white paint, high refractive index particles in another medium or drop-casted without a binding medium, and pigmented polyvinyl butyral (PVB) encapsulate. These pigmented back reflectors provide an obvious low cost advantage compared to sputtered metal back reflectors and typically result in >40% enhancement in photocurrent and efficiency compared to without back reflector. However, these pigmented back reflectors have only been applied to superstrate configured thin film solar cells; that is, the absorber material is deposited onto glass and the back reflector is the last layer deposited. To take advantage of low cost roll-to-roll manufacturing methods, substrate configured solar cells are needed; that is, the absorber is deposited on flexible materials, such as thin metal or plastic foils. To date, the only back reflector technology suitable for substrate configured thin film solar cells has been sputtered metals, since the back reflector is the first deposited layer of the device it needs to be able to withstand the harsh processing conditions used to deposit the solar absorber, such as high-vacuum, high temperature, high density plasma, and roll-to-roll processing. Organic materials and components, such as binders in white paint or encapsulate materials, are not suitable for a harsh processing environment as they can decompose, degas or otherwise contaminate the absorber materials and soil the deposition equipment. Further, previously used methods, such as drop-casting, are very slow at obtaining thick pigmented diffuse back reflectors and not suitable for low cost, high speed manufacturing.

What is needed is atmospheric (low-cost) technology using chemically stable materials to produce films with strong mechanical properties and that exhibit good adhesion on various surfaces.

### SUMMARY OF THE INVENTION

Provided are methods for forming nanoparticle films, including methods based on the technique of electrophoretic deposition. Solutions for use in the methods are also provided. Methods adapted to form nanoparticle films suitable for use as back reflectors in solar cells are also provided. Coated glass windows and methods of forming the coated glass windows are also provided. In addition, the methods as disclosed herein may be used to generate nanoparticle-back reflectors exhibiting high reflection and light scattering properties, including that the nanoparticle-based back reflectors exhibit a higher efficiency than conventional sputtered metal based back reflectors.

In embodiments, a method of forming a nanoparticle film is disclosed including exposing first and second substrate each connected to an electrode, thereby forming a cathode and anode substrate, to a solution, where the solution includes substantially dispersed nanoparticles; an organic solvent, a polysilicate; optionally water; and optionally one or more of an acid and a dopant; and applying a sufficient electric field across the electrodes for a sufficient period of time to deposit a nanoparticle film onto an electrode connected substrate and optionally rinsing the deposited material with a second solvent including acetone, hexane, water, isopropyl alcohol, and combinations thereof.

In one aspect, the nanoparticles include SiO₂ nanoparticles, TiO₂ nanoparticles, ZnO nanoparticles, BaTiO₃ nanoparticles, Ag nanoparticles, Au nanoparticles, Al nanoparticles, Si nanoparticles, BaSO₄ nanoparticles, VO₂ nanoparticles, and combinations thereof.

In another aspect, the method further includes adding a planarizing layer on at least one surface of the nanoparticle film by sol-gel, sputtering, electroplating, or evaporation, and where the planarizing layer comprises nanoparticles that are a different size compared to the dispersed nanoparticles.

In a further aspect, the polymer includes a polysiloxane, a polysilsesquioxane, a polysilicate and combinations thereof. In a related aspect, the organic solvent includes acetone, ethyl alcohol, isopropyl alcohol, n-butyl alcohol, ethyl lactate, ethylene glycol butyl ether and combinations thereof, and wherein said acid is HCl or HNO₃. In another aspect, the method further includes heating the nanoparticle film at between about 0° C. to about 600° C., for between about 30 minutes to about 60 minutes.

In embodiments, a diffuse reflector is disclosed, where the reflector exhibits high refractive index and possesses a bandgap such that the reflector does not absorb visible and/or infrared light.

In one aspect, the nanoparticle film contains holes generated by a method including electrical discharge, poking, scratching, thermal methods, and lithographic methods. In a related aspect, the nanoparticle film comprises conductive nanoparticles in the holes. In a further related aspect, the diffuse reflector is a component in a device including a photovoltaic solar device, and thermo solar device, a thermoelectric device, a UV reflective device, a display, and a lighting device.

In embodiments, a method for modifying a nanoparticle film is disclosed including attaching a first electrode to a conductive substrate comprising the nanoparticle film; connecting a second electrode to a power supply, where a gap is formed between the first and second electrodes; and applying an electric field between the first and second electrodes, whereby the applied electric field causes dielectric breakdown, and thus, creates holes in the nanoparticle film.

In one aspect, the first and second electrodes are asymmetric with respect to area.

In embodiments, a back reflector is disclosed containing a first layer including a light reflecting and scattering layer containing a first plurality of nanoparticles having a diameter between about 0.1 to about 1.0 μm, wherein the first layer is about 1 to about 50 μm thick and a second layer comprising a smoothing layer containing a second plurality of nanoparticles having a diameter of about 1 to 50 nm, where the thickness of the second layer is about 0.1 to about 2 μm thick.

In one aspect, the first plurality of nanoparticles includes a dielectric, non-absorbing material including TiO₂, ZnO, BaSO₄, SiO₂, and BaTiO₃, and where the second plurality of nanoparticles comprises a transparent material. In another aspect, the transparent material includes a transparent conducting oxide (TCO).

In a related aspect, the back reflector includes a planarizing layer.

In embodiments, a method of forming a nanoparticle film on a substrate is disclosed including exposing a substrate to a solution, where the solution includes substantially dispersed nanoparticles; a first organic solvent; and a polymer characterized by a backbone comprising Si—O groups; and depositing said nanoparticles on said substrate by a method including applying an electric field to the solution, dipping, spinning, spraying, and gravure printing, whereby a nanoparticle film is deposited on the substrate.

In one aspect, the method further includes curing the nanoparticle film by IJV or thermal radiation. In a related aspect, the nanoparticle film is applied to a glass substrate, thereby resulting in low emissivity glass.

In another aspect, the nanoparticles comprise quantum dots.

Principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts an illustrative embodiment of an apparatus for carrying out certain of the disclosed methods (A) and a nanoparticle film formed using the apparatus (B).

FIG. 2 shows a photograph image (A), a SEM image (B) and a diffuse reflectance spectrum (C) of a BaTiO₃ nanoparticle film formed via an illustrative embodiment of the disclosed methods.

FIG. 3 depicts a thin film solar cell comprising a nanoparticle film formed via an illustrative embodiment of the disclosed methods. The nanoparticle film is suitable for use as the back reflector in the solar cell.

FIG. 4 depicts a coated glass window formed via an illustrative embodiment of the disclosed methods. The low emissivity coating comprises nanoparticles dispersed throughout a continuous SiO₂ matrix.

FIG. 5 shows the normalized diffuse reflectance and transmission spectra of a silver nanoparticle film formed via an illustrative embodiment of the disclosed methods, demonstrating that the nanoparticle film is suitable for use as a low emissivity coating for a glass window.

FIG. 6 shows a photo (a) and SEM (b) of holes created in TiO₂ nanoparticle film using a electrical discharge method.

FIG. 7 shows an SEM of ITO nanoparticles filing in a hole in TiO₂ nanoparticle film; ITO nanoparticles uniformly coat the top of the non-hole regions of the TiO₂ nanoparticle film.

FIG. 8 shows a graph of diffuse reflectance values for films subjected to various rinsing solvents.

FIG. 9 shows a flow chart for identifying nanoparticle-based back reflector material.

FIG. 10 shows an SEM of surface and cross-section morphology of a back reflector prepared by the EPD method.

FIG. 11 shows a diagram of a laminated nanoparticle-based film on flexible substrate.

FIG. 12 shows a diffuse reflectance of larger (410 nm) nanoparticle TiO₂ film with and without smaller (25 nm) TiO₂ nanoparticles and with spin coated ZnO solution.

FIG. 13 shows total (T) and diffuse (D) reflectance of the nanoparticle-based back reflector and Ag/ZnO and Al/ZnO back reflectors.

FIG. 14 shows prior art-substrate configured thin film solar cell with conventional sputtered back reflector consisting of metal reflecting layer and buffer layer.

FIG. 15 shows a substrate configured thin film solar cell with new pigmented reflector consisting of diffuse reflector layer (larger particles) and smoothing layer (smaller particles).

FIG. 16 shows substrate configured nanostructured solar cell with new pigmented reflector; smoothing layer now acts as a “scaffold” for solar absorber film; diffuse reflector layer has same function.

FIG. 17 shows a diagram for a roll-to-roll system.

FIG. 18 shows total and diffuse reflectance of TiO₂ nanoparticle based film.

FIG. 19 shows diffuse reflectance for various sized TiO₂ particles in nanoparticle-based films.

FIG. 20 shows diffuse reflectance for various materials used in the preparation of nanoparticles.

FIG. 21 shows a SEM image of typical 410 nm TiO₂ nanoparticle-based back reflector demonstrating packing density of the nanoparticles.

FIG. 22 shows current-voltage curves for solar cells containing nanoparticle-based back reflector, Al/ZnO and Ag/ZnO back reflectors.

FIG. 23 shows TiO₂ deposited on 2 inch by 8 inch roll of stainless steel foil.

FIG. 24 shows 3D laser scanner images comparing 400 nm TiO₂ (DuPont) nanoparticle-based back reflector surface morphology with different drying conditions. The sample conditions consisted of: (a) unpolished aluminum substrate, (b) vertically air dried, (c) horizontally air dried, (d) hot plate heating, and (e) hot air.

### DETAILED DESCRIPTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “a nanoparticle” includes one or more nanoparticles, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

The word “illustrative” is used herein to mean serving as an example, instance, or illustration. Any aspect or design described herein as “illustrative” is not necessarily to be construed as preferred or advantageous over other aspects or designs. Further, the use of “and” or “or” is intended to include “and/or” unless specifically indicated otherwise, where it is understood, for example, that “and/or” means a first component alone, second component alone, or first and second component together, and where such may be interpreted to mean at least one of a first component and a second component.

As will be understood by one skilled in the art, for any and all purposes, particularly in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like includes the number recited and refers to ranges which can be subsequently broken down into sub-ranges as discussed above. Finally, as will be understood by one skilled in the art, a range includes each individual member.

As used herein, “about,” “approximately,” “substantially” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term and “substantially” and “significantly” will mean plus or minus >0% of the particular term. Other terms such as “consisting” or “consisting essentially of” may be used to describe the products as disclosed herein.

As used herein, “substantially dispersed” means particles distributed more or less evenly throughout a fluid/medium.

As used herein “sufficient electric field” means applying enough voltage and/or amperage to achieve motion of dispersed particles relative to a fluid/medium.

As used herein “sufficient period of time” means applying a uniform electric field in a fluid/medium containing dispersed particles for a long enough duration to deposit said dispersed particles as a uniform film onto a substrate.

As used herein, “dielectric breakdown” means the rapid reduction in the resistance of an electrical insulator (e.g., air) when the voltage applied across it exceeds the breakdown voltage. This results in a portion of the insulator becoming electrically conductive. Electrical breakdown may be a momentary event (as in an electrostatic discharge), or may lead to a continuous arc discharge if protective devices fail to interrupt the current in a high power circuit.

As used herein, “planarizing” means a process that removes surface topologies, smoothes and flattens a surface.

As used herein, “a diffuse reflector” is a device which causes the reflection of light from a surface such that an incident ray is reflected at many angles rather than at just one angle as in the case of specular reflection.

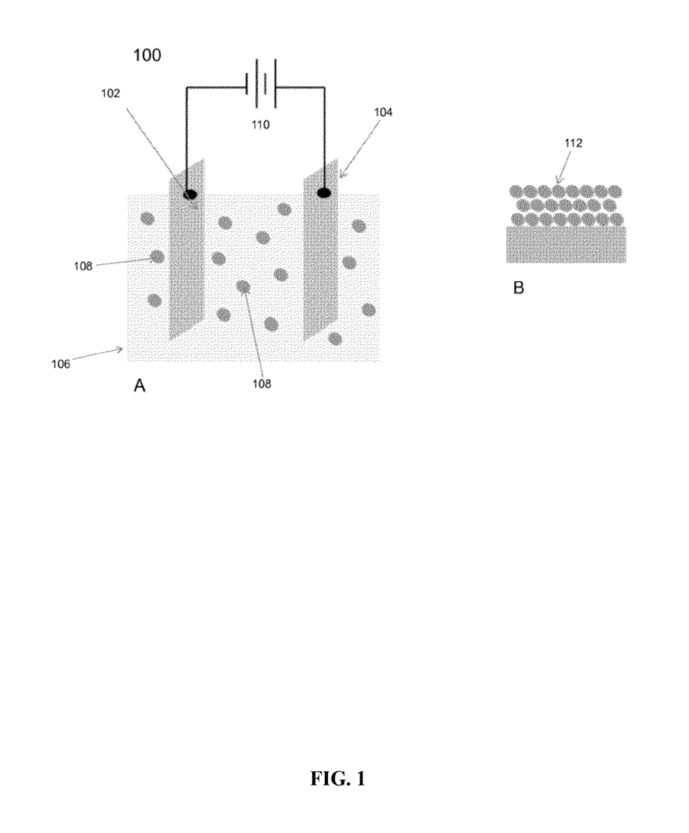

As disclosed herein, different nanoparticle material types with varying sizes may be deposited into films on a substrate (e.g., but not limited to aluminum, glass, steel, plastic or the like) by an electrophoresis deposition (EPD) method using a stabilizing solution (see FIG. 1). The deposited nanoparticle films as disclosed herein exhibit excellent cohesion and adhesion qualities over the entire substrate. The nanoparticle-based films of the present disclosure show high diffuse reflectance (>90%) with strong scattering effects. It was observed that the characteristics of nanoparticle film quality, such as surface roughness and thickness were greatly impacted by particle size, applied voltage, and deposition time. For example, film thickness may be directly proportional to supply voltage and deposition time, which in turn may cause the change in diffuse reflectance. Films as disclosed exhibit similar diffuse reflectance spectra, as well as share similar visual thickness and uniformity.

Provided are methods for forming nanoparticle films, including methods based on the technique of electrophoretic deposition. Solutions for use in the methods are also provided. Methods adapted to form nanoparticle films suitable for use as back reflectors in solar cells are also provided. Coated glass windows and methods of forming the coated glass windows are also provided.

At least some embodiments of the disclosed methods are capable of providing high quality nanoparticle films, including films exhibiting strong adhesion to the underlying substrates, dense nanoparticle packing and uniform morphology, e.g., substantially no cracking and/or substantially no rippling. At least some embodiments of the disclosed methods provide cost savings, as they require only inexpensive, simple equipment and involve low energy consumption and low cost of materials. At least some embodiments of the nanoparticle films formed using the disclosed methods exhibit strong adhesion to underlying substrates, minimized migration of film components into surrounding material layers and high chemical stability while exhibiting high reflectivity and light scattering over the visible spectrum. At least some embodiments of the disclosed methods allow for the deposition of nanoparticle films having textured surfaces without requiring any separate, post-deposition texturing step. At least some embodiments of the disclosed methods are compatible with other typical methods for depositing other material layers of thin film solar cells, eliminating the need for separate processing lines.

Some of the disclosed methods comprise exposing a substrate to a solution comprising nanoparticles and applying an electric field to the solution, whereby a nanoparticle film is deposited on the substrate via electrophoretic deposition. An exemplary apparatus 100 for carrying out an embodiment of such methods is shown in FIG. 1A. An electrode 102 and a substrate 104 acting as a counter electrode are exposed to a solution 106 comprising dispersed nanoparticles 108. An electric field is applied to the solution using a power supply 110. Under the influence of the electric field, the nanoparticles 108 are transported to the substrate 104, where they deposit to form a densely-packed film 112 as shown in FIG. 1B. Prior to describing such methods in greater detail, the solutions for use in the disclosed methods will be described.

In embodiments, a method of forming a back reflector for a solar cell is disclosed including exposing a substrate to a solution, where the solution contains substantially dispersed nanoparticles; an organic solvent; and a polymer characterized by a backbone comprising Si—O groups, applying an electric field to the solution, whereby a nanoparticle film is deposited on the substrate to provide the back reflector, and incorporating the back reflector into a solar cell or other functional material, where the polymer is a polysiloxane, further where the nanoparticles include but are not limited to SiO₂ nanoparticles, TiO₂ nanoparticles, ZnO nanoparticles, BaTiO₃ nanoparticles. BaSO₄ nanoparticles and combinations thereof, further wherein the organic solvent is selected from acetone, ethyl alcohol, isopropyl alcohol, n-butyl alcohol, ethyl lactate, ethylene glycol butyl ether and combinations thereof, and further wherein the solution comprises water and optionally, an acid. In embodiments, after deposition, film uniformity, cohesion and adhesion may then be determined, and in a related aspect, the light reflection and scattering properties may then be characterized. In one aspect, process variables such as time, applied voltage, and solution concentration are varied to identify effective back reflector materials. In one aspect, multiple layers of nanoparticles with varying material types and sizes may be deposited.

In one aspect, a substrate contains a deposited layer of a solution on a surface, where the solution includes substantially dispersed nanoparticles; an organic solvent; and a polymer characterized by a backbone having Si—O groups; where the organic solvent is evaporated from the deposited layer, whereby a coating comprising the nanoparticles dispersed throughout a polymeric matrix comprising a backbone comprising Si—O groups is formed on the surface.

In embodiments, dielectric nanoparticle-based films as solar cell back reflectors are disclosed. Back reflectors increase thin film solar cell efficiencies by decreasing the amount of light available for the cell to absorb and convert to electricity. Since light absorption is proportional to the thickness of the absorber material, thin film solar cells are less capable of absorbing sunlight without a back reflector to redirect unabsorbed light back into the solar cell.

The nanoparticle coating technology as disclosed herein uses low cost materials and methods to deposit dense and uniform dielectric particle-based film. Key properties include:

1) Low cost materials and deposition method (atmospheric) compared to high vacuum methods, which are high cost, energy intensive, and time consuming;

2) Strong adhesion and mechanical durability;

3) Flexibility, and thus applicability to a wide range of thin film technologies and market applications;

4) Deposited in spin-on-glass (SOG) solution, which contains an inorganic polymer with Si—O backbone, is intermixed with the particles deposited in a film which gives the resulting film the strong adhesion and mechanical durability properties;

5) High degree of flexibility before damage of the film is visibly seen.

### Solutions

The solutions for use in the disclosed methods comprise nanoparticles, an organic solvent and a silicon-oxygen-based polymer. Each of these components is further described below.

### Nanoparticle

Solutions for use in the disclosed methods comprise nanoparticles. In some embodiments, the nanoparticles have a maximum dimension in the range from about 1 nm to about 1000 μm. This includes embodiments in which the nanoparticles have a maximum dimension in the range from about 1 nm to about 500 μm; from about 1 nm to about 250 μm; from about 1 nm to about 100 μm; from about 1 nm to about 50 μm; from about 1 nm to about 10 μm; from about 1 nm to about 5 μm; from about 1 nm to about 1 μm; from about 50 nm to about 1 μm; from about 100 nm to about 1 μm; from about 250 nm to about 1 μm; from about 500 nm to about 1 μm, from about 1 nm to about 100 nm; and from about 100 nm to about 500 nm. Both spherical and nonspherical (e.g., rods, tubes, fibers) nanoparticles may be used.

The nanoparticles may be composed of a variety of materials. In some embodiments, the nanoparticles comprise, consist of, or consist essentially of a metal. Exemplary metals include Al, Au, Ag, Pt, Pd, Ni, Fe, and alloys thereof. In some embodiments, the nanoparticles are composed of a metal oxide. Exemplary metal oxides include TiO₂, ZnO and VO₂. In some embodiments, the nanoparticles are composed of a ceramic. Exemplary ceramics include BaTiO₃ and SrTiO₃. In some embodiments, the nanoparticles are composed of a semiconductor. Exemplary semiconductors include group IV, group III-V and group II-VI semiconductors. More specifically, exemplary semiconductors include Si, Ge, SiGe, GaAs and CdTe. In some embodiments, the nanoparticles are composed of a dielectric. Exemplary dielectric materials include SiO₂, TiO₂, ZnO and BaTiO₃. The solutions may comprise various combinations of different types of nanoparticles. In some embodiments, the nanoparticles are selected from the group consisting of SiO₂ nanoparticles, TiO₂ nanoparticles, ZnO nanoparticles and BaTiO₃ nanoparticles. In some embodiments, the nanoparticles are BaTiO₃ nanoparticles. In some embodiments, the nanoparticles are Ag nanoparticles. In some embodiments, the nanoparticles are Si nanoparticles. In some embodiments, the nanoparticles are BaSO₄ nanoparticles. The nanoparticles may be undoped or doped. For example, vanadium oxide nanoparticles may be undoped or doped with tungsten, molybdenum, niobium or fluorine. In embodiments, nanoparticles may comprise carbon nanoparticles and/or quantum dots. In a related aspect, quantum dots may comprise cadmium selenide, cadmium sulfide, indium arsenide, indium phosphide, cadmium selenide sulfide, zinc sulfide, zinc selenide, copper indium sulfide, silicon, and combinations thereof. In a related aspect, quantum dots may be core type or core-shell type, and may contain various alloys including, but not limited to, copper indium sulfide, cadmium selenide sulfide. In a related aspect, core types may include, but are not limited to cadmium selenide; cadmium sulfide; indium arsenide; indium phosphide; zinc sulfide; zinc selenide; and silicon. Further, core-shell types may include, cadmium selenide (core)—zinc sulfide (shell); cadmium sulfide (core)—zinc sulfide (shell); cadmium sulfide (core)—zinc sulfide (shell); cadmium sulfide (core)—zinc selenide (shell); and variations with indium phosphide, which combinations will be apparent to one of skill in the art.

Various amounts of nanoparticles may be used. In some embodiments, the amount of the nanoparticles in the solution is sufficient to provide a nanoparticle film having a desired area and desired thickness. In some embodiments, the amount of the nanoparticles in the solution is in the range from about 0.00005 g/mL to about 0.5 g/mL, where grams refers to the weight of the nanoparticles added to the solution and mL refers to the volume of the solution to which the nanoparticles are added. This includes embodiments in which the amount of the nanoparticles in the solution in is the range from about 0.0005 g/mL to about 0.05 g mL, from about 0.0001 g/mL to about 0.01 g/mL, from about 0.0001 g/mL to about 0.005 g/mL, or from about 0.001 g/mL to about 0.05 g/mL.

### Organic Solvents

Solutions for use in the disclosed methods also comprise an organic solvent. Suitable organic solvents include alcohols, diols, esters, ethers and ketones. Exemplary alcohols include isopropyl alcohol, ethyl alcohol and n-butyl alcohol. Exemplary diols include hexylene glycol. Exemplary esters include ethyl acetate and ethyl lactate. Exemplary ethers include ethylene glycol butyl ether. Exemplary ketones include acetone and methyl isobutyl ketone. Toluene is another suitable organic solvent. Solutions for use in the disclosed methods may comprise various combinations of different organic solvents. Exemplary combinations of organic solvents are provided in Table 1, below.

Various amounts of organic solvent in the solutions may be used. In some embodiments, the w/w % of the organic solvent in the solution is in the range from about 50% to about 99%. This includes embodiments in which the w/w % of the organic solvent in the solution is in the range from about 50% to about 95%; from about 50% to about 90%; from about 55% to about 99%; from about 55% to about 95%; from about 55% to about 90%; from about 60% to about 99%; from about 60% to about 95%; from about 60% to about 90%; from about 65% to about 99%; from about 65% to about 95%; from about 65% to about 90%; from about 70% to about 99%; from about 70% to about 95%; from about 70% to about 90%; from about 75% to about 99%; from about 75% to about 95%; from about 75% to about 90%; from about 80% to about 99%; from about 80% to about 95%; from about 80%9/to about 90%; from about 85% to about 99%; from about 85% to about 95%; from about 85% to about 90%; from about 90% to about 99%; and from about 90% to about 95%. In some embodiments, smaller amounts of organic solvent are used. In some such embodiments, the w/w % of the organic solvent (e.g., toluene) in the solution is in the range of from about 1% to about 5%. These w/w % refer to the percent by weight of the organic solvent compared to the total weight of the solution, i.e., (weight of the organic solvent/total weight of the solution)*100. However, in these w/w %, the total weight of the solution does not include the weight of any nanoparticles in the solution. These w/w % may refer to the w/w % of an individual type of organic solvent in the solution or the w/w % of all the organic solvents in the solution.

### Polymers

Solutions for use in the disclosed methods also comprise certain silicon-oxygen-based polymers. In some embodiments, the solutions comprise a polymer having a backbone comprising silicon-oxygen (Si—O) groups.

In some embodiments, the polymer is characterized by Formula I

(RₙSiO_{(4-n)/2})ₘ Formula I

wherein n=0, 1, 2 or 3; m≧2; and R is independently selected from the group consisting of hydrogen, an unsubstituted hydrocarbon, a substituted hydrocarbon and a halogen.

An unsubstituted hydrocarbon is a hydrocarbon which does not contain a heteroatom. Exemplary unsubstituted hydrocarbons include straight, branched or cyclic alkyl groups; straight, branched or cyclic alkenyl groups; and aryl groups. In some embodiments, the number of carbon atoms in the unsubstituted hydrocarbons is in the range from 1 to 10. This includes embodiments in which the number of carbon atoms in the unsubstituted hydrocarbons is in the range from 1 to 6, from 1 to 3 and from 1 to 2.

A substituted hydrocarbon is a hydrocarbon as defined above in which one or more bonds to a carbon(s) or hydrogen(s) are replaced by a bond to non-hydrogen and non-carbon atoms. Exemplary non-hydrogen and non-carbon atoms include a halogen atom such as F and Cl; an oxygen atom in groups such as hydroxyl and alkoxy; and a nitrogen atom in groups such as alkylamines.

Although polymers having low values of m (e.g., m=2 or 3) may be used in the disclosed solutions, polymers having larger values of m may also be used. In some embodiments, m is in the range from about 10 to about 10,000. In some embodiments, n=1, 2 or 3 and R is independently selected from the group consisting of hydrogen, alkyl, and aryl. In some embodiments, n=1, 2 or 3 and R is independently selected from the group consisting of hydrogen, methyl, and phenyl. In some embodiments, n=1 and R is independently selected from the group consisting of hydrogen and alkyl. In some embodiments, n=1 and R is independently selected from the group consisting of hydrogen and methyl. In some embodiments, n=1 and R is hydrogen. In some embodiments, n=0.

In some embodiments, the polymer is a polysiloxane. In some embodiments, the polymer is a polysiloxane comprising alkyl groups bonded to at least some of the silicon atoms in the polymer. In some embodiments, the polymer is a polysiloxane comprising methyl groups bonded to at least some of the silicon atoms in the polymer. Such polymers may be referred to as methyl polysiloxanes or methyl siloxane polymers. In some embodiments, the polymer is a polysiloxane comprising aryl groups bonded to at least some of the silicon atoms in the polymer. In some embodiments, the polymer is a polysiloxane comprising phenyl groups bonded to at least some of the silicon atoms in the polymer. Such polymers may be referred to as phenyl polysiloxanes or phenyl siloxane polymers. In some embodiments, the polymer is a polysiloxane comprising alkyl groups bonded to at least some of the silicon atoms in the polymer and aryl groups bonded to at least some other of the silicon atoms in the polymer. In some embodiments, the polymer is a polysiloxane comprising methyl groups bonded to at least some of the silicon atoms in the polymer and phenyl groups bonded to at least some other of the silicon atoms in the polymer. In each of these embodiments, various w/w % of the alkyl groups and aryl groups in the polymer may be used. In some embodiments, the w/w % of the alkyl groups, aryl groups, or both, is in the range from about 10% to about 25%. This includes embodiments in which the w/w % of the alkyl groups, aryl groups, or both is in the range from about 10% to about 20% or from about 10% to about 15%. These w/w % refer to the percent by weight of the substituent groups in the polymer compared to the total weight of the polymer. In some embodiments, the polymer is hexamethyldisiloxane. In some embodiments, the polymer is octamethyltrisiloxane.

In some embodiments, the polymer is a polysiloxane characterized by Formula II

(R₂SiO)ₘ Formula II

wherein m and R are as defined above with respect to Formula I. In some embodiments, R is independently selected from the group consisting of hydrogen, alkyl and aryl. In some embodiments, R is independently selected from the group consisting of hydrogen, methyl and phenyl. In some embodiments, the w/w % of the alkyl groups, aryl groups, or both, in the polymer is within the range described above.

In some embodiments, the polymer is a polysilsesquioxane. In some embodiments, the polymer is a polysilsesquioxane comprising hydrogen groups bonded to at least some, or substantially all, of the silicon atoms in the polymer. Such polymers may be referred to as hydrogen silsesquioxane or poly(hydridosilsesquioxane). In some embodiments, the polymer is a polysilsesquioxane comprising alkyl groups bonded to at least some of the silicon atoms in the polymer. In some embodiments, the polymer is a polysilsesquioxane comprising methyl groups bonded to at least some of the silicon atoms in the polymer. In some embodiments, the polymer is a polysilsesquioxane comprising aryl groups bonded to at least some of the silicon atoms in the polymer. In some embodiments, the polymer is a polysilsesquioxane comprising phenyl groups bonded to at least some of the silicon atoms in the polymer. In some embodiments, the polymer is a polysilsesquioxane comprising alkyl groups bonded to at least some of the silicon atoms in the polymer and aryl groups bonded to at least some other of the silicon atoms in the polymer. In some embodiments, the polymer is a polysilsesquioxane comprising methyl groups bonded to at least some of the silicon atoms in the polymer and phenyl groups bonded to at least some other of the silicon atoms in the polymer. In each of these embodiments, various w/w % of the alkyl groups and aryl groups in the polymer may be used. The w/w % of the alkyl groups, aryl groups, or both, in the polymer is within the range described above with respect to polysiloxanes.

In some embodiments, the polymer is a polysilsesquioxane characterized by Formula III

(RSiO_{1.5})ₘ Formula III

wherein m and R are as defined above with respect to Formula I. In some embodiments, R is hydrogen. In some embodiments, R is independently selected from the group consisting of hydrogen, alkyl and aryl. In some embodiments, R is independently selected from the group consisting of hydrogen, methyl and phenyl. In some embodiments, the w/w % of the alkyl groups, aryl groups, or both, in the polymer is within the range described above.

In some embodiments, the polymer is a polysilicate. The polysilicates may be characterized by a chain of SiO₂ groups and may be referred to as polymeric silica. The polysilicates may be distinguished from the polysiloxanes and polysilsesquioxanes described above at least by the substantial absence of any R groups bonded to the silicon atoms. The polysilicates may be the reaction product of tetraethyl orthosilicate (TEOS) and water.

In some embodiments, the polymer is a polysilicate characterized by Formula IV

(SiO₂)ₘ Formula IV

wherein m is as defined above with respect to Formula I.

Any of the polymers described above may also comprise one or more silanol groups (e.g., a terminal silanol group).

The disclosed solutions may comprise various combinations of different types of the polymers described above. In some embodiments, the solution comprises a polysilsesquioxane and a polysiloxane. In some embodiments, the solution comprises a polysilsesquioxane and a first polysiloxane and a second polysiloxane. Exemplary polymers and combinations are provided in Table 1, below.

Other polymers may include those as disclosed in U.S. Pub. Nos. 20060074172 and 20090004462, each of which is incorporated by reference in their entireties.

Various amounts of the polymer may be used in the disclosed solutions. In some embodiments, the amount of polymer is that which is sufficient to substantially disperse the nanoparticles within the solution, as compared to the solution without the polymer, such that the solution is substantially free of agglomerations of individual nanoparticles. Standard methods may be used to evaluate the dispersion of the nanoparticles and the presence of agglomeration. In some embodiments, the w/w % of the polymer in the solution is in the range from about 1% to about 50%. This includes embodiments in which the weight % of the polymer in the solution is in the range from about 1% to about 20%; from about 1% to about 15%; from about 1% to about 10%; from about 2% to about 20%; from about 2% to about 15%; from about 2% to about 10%; from about 5% to about 50%; from about 5% to about 40%; from about 5% to about 20%; from about 5% to about 15%; from about 5% to about 10%, from about 10% to about 40%; from about 10% to about 30%; from about 10% to about 20%; from about 15% to about 40%; from about 15% to about 35%; and from about 15% to about 20%. In some embodiments, larger amounts of polymer are used. In some such embodiments, the w/w % of the polymer in the solution is in the range of from about 90% to about 99% or from about 95% to about 99%. These w/w % refer to the percent by weight of the polymer in the solution compared to the total weight of the solution, i.e., (weight of the polymer/total weight of the solution)*100. However, in these w/w %, the total weight of the solution does not include the weight of any nanoparticles in the solution. These w/w % may refer to the w/w % of an individual type of polymer in the solution or the w/w % of all the polymers in the solution.

In some embodiments, the polymer is a polysiloxane and is present in the solution in an amount (w/w %) in the range from about 10% to about 20%; from about 2% to about 15%; or from about 5% to about 10%. In some embodiments, the polymer is a polysilsesquioxane and is present in the solution in an amount (w/w %) in the range from about 5% to about 40%; from about 5% to about 20%; from about 5% to about 15%; from about 10% to about 30%; or from about 15% to about 35%. In some embodiments, the polymer is a polysilicate and is present in the solution in an amount (w/w %) in the range from about 1% to about 25%; from about 1% to about 20%; from about 1% to about 15%; from about 1% to about 10%; or from about 1% to about 5%. In some embodiments, the solution comprises a polysiloxane and a polysilsesquioxane, wherein the polysiloxane is present in an amount (w/w %) in the range from about 60% to about 80% or from about 70% to about 90% and the polysilsesquioxane is present in an amount (w/w %) in the range from about 10% to about 30% or from about 15% to about 35%. Any of the polysiloxanes, polysilsesquioxanes and polysilicates described above may be used. In these w/w %, the total weight of the solution does not include the weight of any nanoparticles in the solution.

### Additional Components

Solutions for use in the disclosed methods can further comprise additional components. Water may be an additional component. When present, various amounts of water may be used. In some embodiments, water is present in an amount (w/w %) in the range from about 1% to about 30%. This includes embodiments in which water is present in an amount from about 1% to about 20%; from about 1% to about 15%; from about 1% to about 10%; from about 1% to about 5%; from about 5% to about 30%; from about 5% to about 20%; from about 5% to about 15%; and from about 5% to about 10%. In some embodiments, water is present in an amount (w/w %) of at least 5%, at least 10%, at least 15%, or at least 20%. Other additional components include an acid, such as hydrochloric acid (HCl) or nitric acid (HNO_{I}), and a dopant, such as P₂O₅. Various amounts (w/w %) of these additional components may be used, for example, from about 1% to about 5%. In these w/w %, the total weight of the solution does not include the weight of any nanoparticles in the solution.

Table 1, below, includes exemplary blends of organic solvents, polymers and additional components for use in the disclosed solutions. For use in the disclosed methods, any of the nanoparticles described above in any of the amounts described above are to be added to these exemplary blends. Thus, in the w/w % in Table 1, the total weight of the blend does not include the weight of any nanoparticles to be added to the blend.

TABLE 1
Exemplary blends of organic solvents, polymers and
additional components for use in the disclosed solutions.

| Blend | Ingredient | w/w % |
|---|---|---|
| A | Polysiloxane | 1-25% |
| | Isopropyl Alcohol, Ethyl Alcohol, Ethylene | 50-98% |
| | Glycol Butyl Ether | |
| | Water | Remainder |
| | Hydrochloric Acid or Nitric Acid | 0-5% |
| B | Methyl Silsesquioxane Polymer | 5-40% |
| | Ethyl Acetate | 0-45% |
| | n-Butyl Alcohol | 50-90% |
| C | Methyl Siloxane Polymer | 12-17% |
| | Acetone | 11-19% |
| | Ethyl Alcohol | 28-36% |
| | Isopropyl Alcohol | 25-35% |
| | Water | Remainder |
| D | Organosiloxane Polymer | 5-10% |
| | Ethyl Alcohol | 8-18% |
| | Isopropyl Alcohol | 16-26% |
| | n-Butyl Alcohol | 1-5% |
| | Acetone | 5-15% |
| | Ethyl Lactate | 35-45% |
| | Water | Remainder |
| E | Methyl Isobutyl Ketone | 85-100% |
| | Hydrogen Silsesquioxane | 10-30% |
| | Toluene | <1% |
| F | Methyl Isobutyl Ketone | 70-90% |
| | Hydrogen Silsesquioxane, hydroxy-terminated | 15-35% |
| | Toluene | 1-5% |
| G | Octamethyltrisiloxane | 55-75% |
| | Hexamethyldisiloxane | 15-35% |
| | Hydrogen Silsesquioxane | 10-30% |
| | Toluene | <1% |
| H | Octamethyltrisiloxane | 40-70% |
| | Hexamethyldisiloxane | 15-40% |
| | Hydrogen Silsesquioxane | 15-40% |
| | Toluene | 1-5% |
| I | Octamethyltrisiloxane | 40-60% |
| | Hexamethyldisiloxane | 15-35% |
| | Hydrogen Silsesquioxane, hydroxy-terminated | 15-35% |
| | Toluene | 1-5% |
| J | Polysilicate | 2.5-11% |
| | Organic Solvent (isopropyl alcohol major component) | Remainder |
| | Water | 5-7% |
| | P₂O₅ Dopant | 0-4% |
| K | Polysiloxane, 10-14.5% methyl groups | 4-15% |
| | Organic Solvent (isopropyl alcohol major component) | Remainder |
| | Water | 4-11% |
| L | Polysiloxane, 24% phenyl groups | 7-9% |
| | Organic Solvent (isopropyl alcohol major component) | Remainder |
| | Water | 5-7% |
| M | Polysilsesquioxane, 12-16% methyl groups | 7-15% |
| | Organic Solvent (isopropyl alcohol major component) | Remainder |
| N | Polysilsesquioxane, 13-15.5% methyl and phenyl | 7.5-16% |
| | groups | |
| | Organic Solvent (isopropyl alcohol major component) | Remainder |

Commercially available versions of Blends A-N include the following: SilicAR LR-800S (Industrial Science & Technology Network); FG65 (Filmtronics); ACCUGLASS® T-12B (Honeywell); SLAM248.2100.200 mm (Honeywell), FOX®-14, 15, 16, 22, 24 and 25 Flowable Oxides (Dow Corning); Silicate Family 15SA/20B (Filmtronics); Phosphosilicate Family P-15A/P-20B, P-x2F, P-x4F (Filmtronics); Siloxane Family 100F, 500F, x15F, x1F (Filmtronics); and Silsesquioxane Family 200F, 300F, 400F, 550F, 700F (Filmtronics).

Solutions for use in the disclosed methods can consist of, or consist essentially of, any of the nanoparticles described above: one or more of any of the organic solvents described above; one or more of any of the polymers described above; and optionally, one or more of water, an acid, and a dopant. In some embodiments, the solution consists of, or consists essentially of, nanoparticles, a polysiloxane, one or more organic solvents, water, and optionally, an acid. In some embodiments, the solution consists of, or consists essentially of, nanoparticles, a polysilsesquioxane, and one or more organic solvents. In some embodiments, the solution consists of, or consists essentially of, nanoparticles, a polysilsesquioxane, one or more polysiloxanes, and one or more organic solvents. In some embodiments, the solution consists of, or consists essentially of, nanoparticles, a polysilicate, one or more organic solvents, water, and optionally, one or more of an acid and a dopant. Any of the nanoparticles, polysiloxanes, polysilsesquioxanes, polysilicates, organic solvents, acids, and dopants described above may be used in any of the amounts described above.

Other exemplary solutions for use in the disclosed methods include the following. In some embodiments, the solution comprises, consists of, or consists essentially of, nanoparticles selected from the group consisting of BaTiO₃ nanoparticles, Ag nanoparticles, Si nanoparticles, SiO₂ nanoparticles, ZnO nanoparticles, TiO₂ nanoparticles, VO₂ nanoparticles and BaSO₄ nanoparticles; one or more polysiloxanes selected from the group consisting of methyl polysiloxane and phenyl polysiloxane: one or more organic solvents; and water. In some such embodiments, the organic solvents are selected from ethyl alcohol, isopropyl alcohol, n-butyl alcohol, acetone and ethyl lactate. Any of the amounts of these components described above may be used.

In some embodiments, the solution comprises, consists of, or consists essentially of, nanoparticles selected from the group consisting of BaTiO₃ nanoparticles. Ag nanoparticles, Si nanoparticles, SiO₂ nanoparticles, ZnO nanoparticles, TiO₂ nanoparticles, VO₂ nanoparticles and BaSO₄ nanoparticles; one or more polysiloxanes; one or more organic solvents; water; and optionally, an acid. In some such embodiments, the organic solvents are selected from hexylene glycol, ethyl alcohol, isopropyl alcohol, and ethylene glycol butyl ether. Any of the amounts of these components described above may be used.

In some embodiments, the solution comprises, consists of, or consists essentially of, nanoparticles selected from the group consisting of BaTiO₃ nanoparticles, Ag nanoparticles, Si nanoparticles, SiO₂ nanoparticles, ZnO nanoparticles. TiO₂ nanoparticles, VO₂ nanoparticles and BaSO₄ nanoparticles; a polysilicate; one or more organic solvents; water; and optionally, one or more of an acid and a dopant. In some such embodiments, the organic solvents are selected from hexylene glycol, ethyl alcohol, isopropyl alcohol and ethylene glycol butyl ether. Any of the amounts of these components described above may be used.

In some embodiments, the solution comprises, consists of, or consists essentially of, nanoparticles selected from the group consisting of BaTiO₃ nanoparticles, Ag nanoparticles, Si nanoparticles, SiO₂ nanoparticles, ZnO nanoparticles, TiO₂ nanoparticles, VO₂ nanoparticles and BaSO₄ nanoparticles; one or more polysilsesquioxanes selected from the group consisting of methyl polysilsesquioxane, polysilsesquioxane comprising methyl and phenyl groups, and hydrogen silsesquioxane; and one or more organic solvents. In some such embodiments, the organic solvents are selected from isopropyl alcohol, n-butyl alcohol, ethyl acetate, methyl isobutyl ketone, and toluene. Any of the amounts of these components described above may be used.

In some embodiments, the solution comprises, consists of, or consists essentially of, nanoparticles selected from the group consisting of BaTiO₃ nanoparticles, Ag nanoparticles, Si nanoparticles. SiO₂ nanoparticles, ZnO nanoparticles, TiO, nanoparticles, VO₂ nanoparticles and BaSO₄ nanoparticles; a hydrogen silsesquioxane; one or more polysiloxanes selected from octamethyltrisiloxane and hexamethyldisiloxane; and one or more organic solvents. In some such embodiments, the organic solvent is toluene. Any of the amounts of these components described above may be used.

In some embodiments, the solution comprises, consists of, or consists essentially of, nanoparticles and a blend selected from the group consisting of Blend A, Blend B. Blend C, Blend D, Blend E, Blend F, Blend G, Blend H, Blend I, Blend J, Blend K, Blend L, Blend M and Blend N. Any of the nanoparticles described above may be used in any of the amounts described above. However, in some embodiments, the nanoparticles are dielectric nanoparticles. In some embodiments, the nanoparticles are selected from the group consisting of BaTiO₃ nanoparticles, Ag nanoparticles, Si nanoparticles, SiO₂ nanoparticles, ZnO nanoparticles, TiO₂ nanoparticles, VO₂ nanoparticles, and BaSO₄, nanoparticles.

In some embodiments, the solution comprises substantially no water. In some embodiments, the solution does not comprise water. In some embodiments, the solution comprises any of the polymers described above, wherein the amount of the polymer is sufficient to improve dispersion of the nanoparticles in the solution as compared to the solution without the polymer and the solution does not comprise any other polymer. In some embodiments, the solution comprises any of the polymers described above, wherein the amount of the polymer is sufficient to improve dispersion of the nanoparticles in the solution as compared to the solution without the polymer and the solution does not comprise any other silicon-oxygen based polymer. In some embodiments, the solution comprises any of the polymers described above, wherein the amount of the polymer is sufficient to improve dispersion of the nanoparticles in the solution as compared to the solution without the polymer and the solution does not comprise any other polysiloxane, polysilsesquioxane or polysilicate.

### Methods

Some of the disclosed methods comprise exposing a substrate to any of the solutions described above and applying an electric field to the solution, whereby a nanoparticle film is deposited on the substrate via electrophoretic deposition. Apparatuses for electrophoretic deposition are known and typically comprise a vessel to hold the solution and electrodes and a power supply to generate an electric field in the solution. An exemplary apparatus 100 has been described above with reference to FIG. 1. The electric field is generated in the solution 106 by supplying a voltage or current via the power supply 110 to the spaced apart electrode 102 and substrate 104 acting as a counter electrode. Various magnitudes of voltage or current may be used. For example, a voltage in the range of from about 0 V to about 1000 V or a current in the range of from about 0 Amps to about 10 Amps may be used. The voltage or current used may be direct, alternating, pulsed or ramped. If applicable (e.g., for alternating voltage or current), various frequencies of the applied voltage or current may be used. For example, a frequency in the range of from about 0 Hz to about 100 kHz may be used. Various distances between the electrode and substrate (counter electrode) may be used. For example, a distance in the range of from about 1 mm to about 100 mm may be used. Various deposition times (i.e., the length of time the electric field is applied) may be used. For example, deposition times in the range of from about 1 s to about 100 min or from about 3 s to about 10 min may be used. The characteristics of the applied electric field, the distance between electrodes and the deposition time may be adjusted to modify the properties of the nanoparticle films thus deposited.

Various conductive substrates may be used in the disclosed methods based on the technique of electrophoretic deposition. Exemplary conductive substrates include glass coated with a transparent conducting oxide, such as indium tin oxide (ITO), stainless steel or other metals, and conductive polymers.

The deposited nanoparticle films may be evaluated by standard methods. Visual inspection may be used to evaluate the uniformity of the film, its overall morphology and its adhesion to the underlying substrate. Microscopic structure and surface roughness may be evaluated using scanning electron microscopy (SEM) and atomic force microscopy (AFM). Diffuse reflectance over certain ranges of wavelengths (e.g., 200 nm to 1400 nm) may be evaluated using a UV-Vis spectrometer coupled with an integrating sphere.

Methods adapted to form nanoparticle films suitable for use as back reflectors in solar cells are also provided. In some embodiments, a nanoparticle film suitable for use as a back reflector in a solar cell is a nanoparticle film that exhibits an average reflectivity over a wavelength range of from about 400 nm to about 1400 nm of at least 60%. This includes embodiments in which the nanoparticle film exhibits an average reflectivity over a wavelength range of from about 400 nm to about 1400 nm of at least 65%, at least 70%, at least 75%, at least 80%, at least 85%, at least 90%, at least 95%, at least 97%, or at least 99%. In some embodiments, a nanoparticle film suitable for use as a back reflector in a solar cell is a nanoparticle film that is characterized by a surface roughness (measured as the average vertical height between the highest and lowest features in the nanoparticle film) in the range of from about 20 nm to about 20 μm. Such nanoparticle films may be referred to as “textured.” In some embodiments, a nanoparticle film suitable for use as a back reflector in a solar cell is a nanoparticle film characterized by a thickness in the range from about 10 nm to about 1 mm. Nanoparticle films suitable for use as a back reflector in a solar cell also include nanoparticle films exhibiting various combinations of the characteristics described above. Methods may be adapted to form these nanoparticle films by the appropriate selection of the solution components (e.g., type/size of nanoparticle, type of organic solvent, type of polymer and amounts thereof) as well as selection of method parameters. Some of the examples below describe methods which have been adapted to form nanoparticle films suitable for use as back reflectors in solar cells.

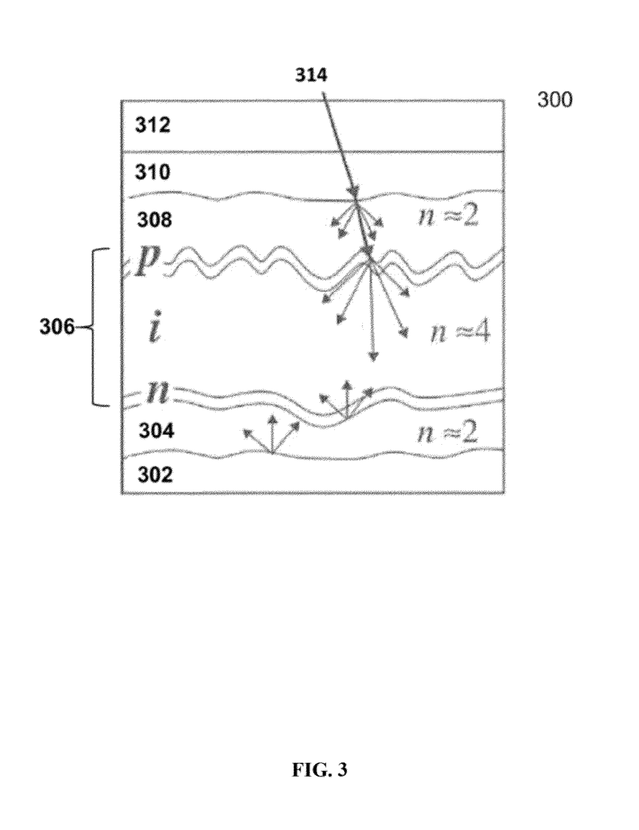

The disclosed methods may comprise a variety of post-deposition steps. For example, the deposited nanoparticle film may be heated in order to anneal the film or to improve electrical conductivity. In another example, the deposited nanoparticle film may be incorporated into a variety of desired devices, including solar cells. Incorporation may be accomplished, for example, by forming other layers of the desired device over the deposited nanoparticle film, e.g., one or more layers of a solar cell. One embodiment of a solar cell is shown in FIG. 3. The solar cell 300 comprises a nanoparticle film 302 suitable for use as a back reflector formed per an embodiment of the disclosed methods. The solar cell further comprises additional layers that have been formed over the deposited nanoparticle film using standard methods, including a buffer layer 304 of ZnO; a Si PIN junction 306; a transparent conductive oxide electrode layer 308 of ITO; a first encapsulation layer 310 of ethylene-vinyl acetate, and a second encapsulation layer 312 of ethylene tetra-fluor-ethylene. By using highly reflective and textured nanoparticle films formed using the disclosed methods as the back reflector 302, incident light 314 is ultimately reflected and scattered by the back reflector back into the absorber layer of the Si PIN junction 306, thereby improving the photocurrent and efficiency of the solar cell. The deposited nanoparticle films may be incorporated into other types of solar cells.

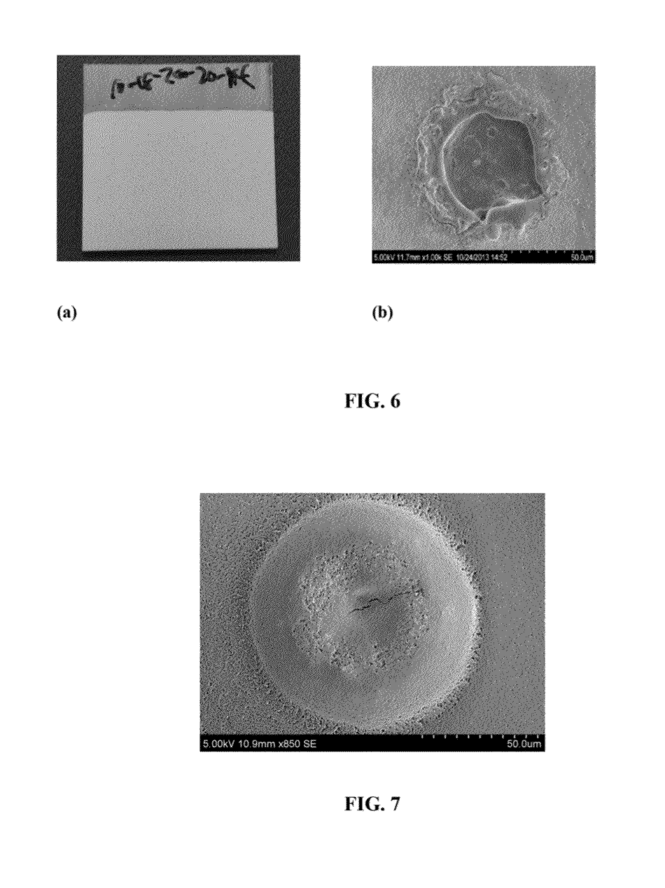

In embodiments, holes or vias may be created in the film (e.g., but not limited to, TiO films). In a related aspect, holes may be produced using electrical discharge, in for example, an aperiodic arrangement (See FIG. 6). Other methods for creating holes include, but are not limited to, mechanical methods such as poking, scratching, thermal methods or lithographic methods and the like which will be apparent to one of skill in the art.

In embodiments, indium tin oxide (ITO) particles or other conductive and transparent particles may be deposited onto films containing holes or vias. For example, ITO particles may uniformly coat a TiO₂ containing film surface, where the holes are filled with ITO (See FIG. 7).

In embodiments, other manipulations of the back reflector that may be used to reduce surface roughness include but are not limited to, planarizing or smoothing out either the TiO₂ or ITO nanoparticle film surface with a thin layer of spin-on-glass (SOG) solution using standard procedures (e.g., dipping) or using other type of sol-gel solutions familiar to those skilled in the art. In one aspect, a ZnO layer may be sputtered on such film surfaces for reducing surface roughness. In a related aspect, a separate layer of smaller size (about 5˜20 nm) relative to the ITO nanoparticles may be added.

The present invention encompasses the various products and devices made using the methods and solutions disclosed herein, e.g., the nanoparticle films, the back reflectors and the solar cells themselves.

### Coated Glass Windows and Methods of Forming the Same

Coated glass windows and methods of forming the coated glass windows are also provided. The coatings are formed using any of the solutions disclosed herein. In one embodiment, a method of forming a coated glass window comprises depositing a layer of any of the solutions disclosed herein onto a surface of a pane of window glass and evaporating the organic solvent from the deposited layer, whereby a coating comprising nanoparticles dispersed throughout a polymeric matrix comprising a backbone comprising Si—O groups is formed on the surface. In some embodiments, the polymeric matrix is a continuous SiO₂ matrix. The depositing step may be repeated in order to form a coating having the desired thickness.

Regarding the solutions to be used in the methods of forming a coated glass window, as noted above, any of the solutions disclosed herein may be used. However, in some embodiments, the nanoparticles have a maximum dimension in the range from about 1 nm to about 100 nm. In some embodiments, the nanoparticles are composed of a material characterized by a low emissivity coefficient. In some embodiments, the nanoparticles comprise, consist essentially of, or consist of Ag nanoparticles, VO₂ nanoparticles, BaSO₄ nanoparticles, or combinations thereof. Nanoparticles may be undoped or doped. For example, VO₂ nanoparticles may be undoped or doped with tungsten, molybdenum, niobium or fluorine. In some embodiments, the amount of the nanoparticles in the solution is sufficient to provide a coating exhibiting an average diffuse reflectance and/or average transmission within the ranges described below. In some embodiments, the amount of the nanoparticles in the solution is in the range from about 0.0001 g/mL to about 0.01 g/mL. In some embodiments, the amount of the nanoparticles in the solution is about 0.001 g/mL.

The step of depositing a layer of the solutions on a surface of a pane of window glass may be accomplished via techniques such as electrophoretic deposition as described above, dip coating, spin coating, spray coating or printing (e.g., gravure). Procedures and conditions for carrying out dip coating, spin coating and spray coating are known.

The methods of forming a coated glass window may further comprise a variety of post-deposition steps. For example, the deposited layer may be heated at a certain temperature for a certain time. Suitable heating temperatures and times can depend upon the particular polymers used in the solutions. Exemplary heating temperatures include those in the range from about 200° C. to about 500° C. and an exemplary heating time is about 1 hour.

In one embodiment, a coated glass window comprises a pane of window glass and a coating on a surface of the pane, the coating comprising nanoparticles dispersed throughout a polymeric matrix comprising a backbone comprising Si—O groups. In some embodiments, the polymeric matrix is a continuous SiO₂ matrix. In some embodiments, the nanoparticles are homogeneously dispersed throughout the polymeric matrix. In some embodiments, the coating is substantially free of agglomerations of individual nanoparticles. Standard methods may be used to evaluate the dispersion of the nanoparticles and the presence of agglomeration.

The coating may be characterized by its thickness. In some embodiments, the coating is characterized by a thickness in the range from about 100 nm to about 0.01 mm. The coating may also be characterized by its ability to transmit and reflect certain wavelengths of light. In some embodiments, the coating transmits light having a wavelength in the range from about 400 nm to about 1000 nm and reflects light having a wavelength in the range from about 1000 nm to about 1400 nm, thereby providing a low emissivity coating. In some embodiments, the coating exhibits an average transmission over a wavelength range of from about 400 nm to about 1000 nm of at least 10%. This includes embodiments in which the coating exhibits an average transmission over this wavelength range of at least 20%, of at least 30%, of at least 40%, of at least 50%, of at least 60%, at least 70%, of at least 80%, or at least 90%. In some embodiments, the coating exhibits an average diffuse reflectance over a wavelength range of from about 1000 nm to about 1400 nm of at least 10%. This includes embodiments in which the coating exhibits an average diffuse reflectance over this wavelength range of at least 20%, of at least 30%, of at least 40%, of at least 50%, of at least 60%, at least 70%, of at least 80%, or at least 90%.

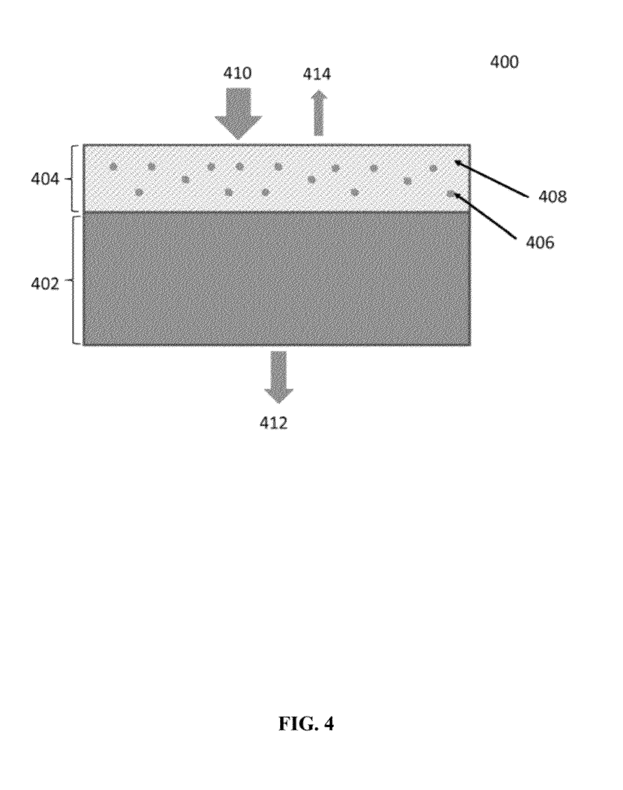

A schematic illustration of a coated glass window 400 is shown in FIG. 4. The coated glass window comprises a pane 402 of window glass and a coating 404 on a surface of the pane. The coating comprises nanoparticles 406 homogeneously dispersed throughout a continuous SiO₂ matrix 408. As solar radiation 410 (encompassing the total spectrum of electromagnetic radiation given off by the sun, including UV radiation, visible radiation and infrared radiation) strikes the coating, the visible radiation is transmitted 412 by the coating and the infrared radiation and/or UV radiation is reflected 414 by the coating. Thus, the coating is a low emissivity coating.

Window glasses that may be coated as described herein include the kind of glasses typically used for the doors and windows of residential homes or commercial buildings.

### Back Reflectors and Methods of Forming Same

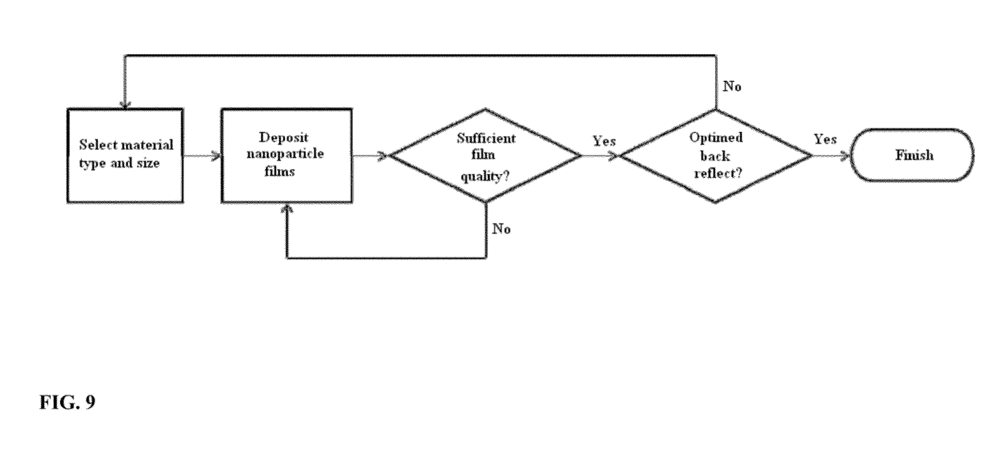

The technical approach to depositing and characterizing the nanoparticle-based films as back reflectors may be seen in FIG. 9. In embodiments, a process for depositing dielectric nanoparticle-based films is disclosed using a solution comprising organic steric stabilizers, such that the nanoparticles do not settle and remain mono-dispersed, in conjunction with an EPD method. In one aspect, the nanoparticle material type and size may be 410 nm titanium dioxide (TiO₂), which material exhibits deposition uniformity, optimal thickness, repeatability, high diffuse reflection, and light scattering properties over a broad spectrum of light (e.g., about 400 nm [blue] to about 1400 nm [infrared]), including that nanoparticle-based back reflectors fabricated from said films exhibit about 80% to about 90% diffuse reflectance over said spectrum (compared to a 25 to 35% exhibited by metal sputtered based back reflectors over the same spectrum of light). In a related aspect, nanoparticles as disclosed herein are suspended in a solution comprising Si—O polymer stabilizers and one or more polar, non-polar a protic, and/or polar aprotic organic solvents, which suspended nanoparticles remain mono-dispersed for long periods of time (hours) without agglomeration or settling. The solution properties ensure high quality nanoparticle film deposition using the EPD method where an applied electric field transports said particles such that they deposit on a substrate in the form of a multilayer film. In embodiments, about 2 to about 5 g, about 2 to about 6 g, about 3 to about 7 g, about 2 to about 10 g about 8 to about 10 g of nanoparticles may be added to about 20, about 25, or about 30 ml of organic/silicon polymer solution. In a related aspect, lower ratios of nanoparticles to solution (e.g., about 2 to about 6 g/20-30 ml) result in films with rougher surfaces. In another related aspect, higher ratios of nanoparticles to solution (e.g., about 8 to about 10 g/20-30 mil) result in films with smoother surfaces.

In a further related aspect, the nanoparticles may be deposited at a deposition rate of about 10 to about 15 μm/min, where said nanoparticles deposit with high uniformity without film defects such as cracking or peeling.

In embodiments, the nanoparticle-based back reflector films exhibit enhanced thin film solar cell efficiency compared to state-of-the-art sputtered metal containing lightweight thin film silicon solar modules. For example, the back reflector films as disclosed herein lead to −85% light reflection and strong scattering properties compared to state of the art sputtered metal back reflectors (e.g., those containing Ag/ZnO and Al/ZnO). Compared to the nanoparticle-based back reflectors of the instant disclosure, the Ag/ZnO and Al/ZnO sputtered metal backed reflectors exhibited lower photocurrent and efficiency. In a related aspect, the nanoparticle-based back reflectors of the present disclosure exhibit almost 3-fold higher diffuse reflectance than conventional metal sputter based back reflectors.

In embodiments, the nanoparticle-based back reflectors as disclosed herein exhibit process scalability and mechanical durability. In one aspect, nanoparticle-based films deposited onto large-area flexible stainless steel substrates exhibit high packing density, which results in strong adhesive forces and high mechanical durability. For example, a substrate containing the back reflector film of the present disclosure is resistant to the effects of bending the coated substrate back and forth. Further, while not being bound by theory, the closely packed nanoparticles effect strong light reflection and scattering due to light diffractions created by multiple high (particle)/low (matrix) refractive index interfaces. In one aspect, a 1.5 inch by 8 inch back reflector film deposited on a stainless steel substrate exhibited resistance to bending the foil back and forth without damaging the back reflector film, demonstrating good adhesion and mechanical durability.

In embodiments, the back reflectors as disclosed herein show:

1) High degree of flexibility before damage of the film is visibly seen:

2) Diffuse reflection (>80% from 420 nm to 1000 nm wavelengths) and strong light scattering (i.e., diffuse reflection) demonstrate that the diffuse reflection and total reflection of back reflector of the instant disclosure are essentially equal:

3) Reduced cost per watt ($/W) compared to current state of the art reflector technologies;

4) Combines reflective light scattering with conductivity, thereby eliminating the need for two separate layers and simplifying device structure and subsequent manufacturing processes; and

5) Unlike white paint and plastic foils, the inorganic components of the back reflectors as recited herein are chemically stable and can withstand harsh fabrication conditions, such as high density plasmas, high temperatures, and high vacuum environments.

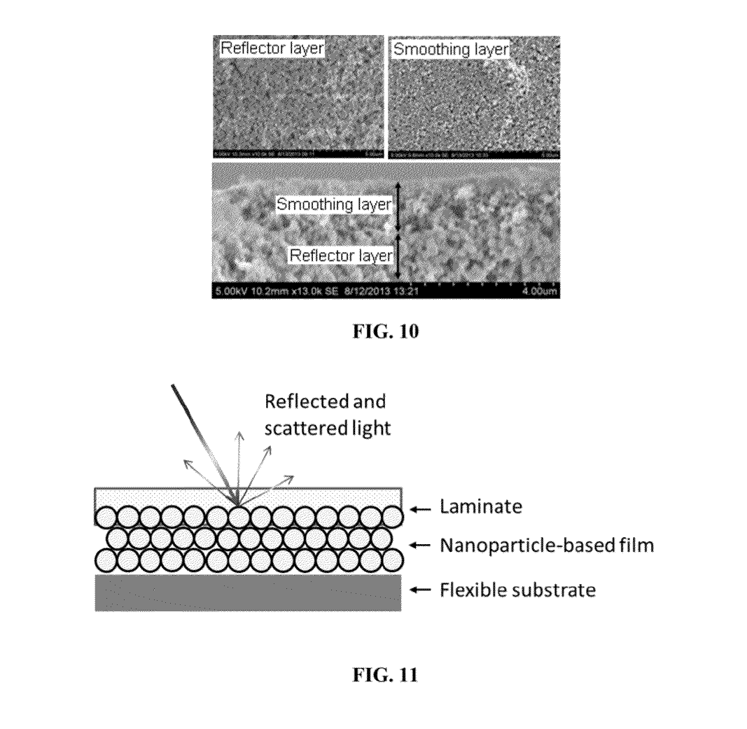

In embodiments, high reflective index particles may be suspended in spin-on-glass solution and electrophoretically deposited into nanoparticle-based films and comprises at least two layers (see, e.g., FIG. 10):

The first layer is the light reflecting and scattering layer and comprises about 0.1 to about 1.0 micron diameter refractive index particles into films with about 1 to about 50 micron thickness. In a related aspect, the particles may be TiO₂ with a diameter of about 0.2 to about 0.5 microns and a thickness of about 20 microns.

The second layer, referred to as a smoothing layer, may be deposited directly onto the first reflecting layer, and comprises particles having a diameter of about 1 to about 50 nm of any material that is transparent (e.g., comprising, but not limited to, silicon, cadmium telluride (CdTe), copper indium gallium arsenide (CIGS), titanium dioxide (TiO₂), silicon dioxide (SiO₂), zinc oxide (ZnO), barium titanate (BaTiO₃), and barium sulfate (BaSO₄)). In a related aspect, the particles may be TiO₂ with a diameter of about 30 nm in films with a thickness of about 0.1 to about 2 microns.

In embodiments, high reflective index and nanoparticle-based films exhibit high reflectance and light scattering, multiple surface reflections, light refraction at multiple high (TiO₂)/low (air) refractive index interfaces, which is analogous to pigment in white paint. Light trapping increases when scattered light is reflected at wide angles to normal, thus affording multiple chances for absorption. The nanoparticle-based back reflectors of the instant disclosure may be used as a back reflector layer for many types of thin film solar cells, such as thin film silicon, CdTe, CIGS and organic-based systems. In one aspect, the nanoparticle-based film as disclosed, especially the smoothing layer, may also be used as a “scaffold” in which solar absorbing materials may be deposited on, such as for example, dye-sensitized solar cells and peroskite solar cells.

In embodiments, the nanoparticle-based back reflectors as disclosed exhibit a resistivity of approximately 100 ohm-meters with rutile TiO₂ particle (˜400 nm diameter) film having 20 micron thickness. In a related aspect, the back reflector exhibit a surface roughness of approximately 30 nm or less when smoothing layer consists of 30 nm diameter particles.

While not being bound by theory, oxides/dielectric materials (e.g., TiO₂, BaSO₄) are chemically stable compared to sputtered metals, especially, for example, silver, which can more easily oxidize and migrate into the sensitive solar absorber material which deteriorates the solar cell performance. Further, pigmented back reflectors, which are typically used for superstrate configured solar cells on glass, are sensitive to mechanical/chemical process stressors usually associated with solar cell fabrication. Back reflectors in superstrate configured solar cells are deposited last and thus have much more relaxed requirements, including that white pigments contain binders which the present reflectors do not. Thus, an advantage of the present back reflectors is compatibility with substrate configured solar cells which must withstand harsh processing conditions of the thin film absorber deposition process, such as high vacuum, high temperature, high density plasma, and mechanical stress from manufacturing methods (e.g., roll to roll).

In embodiments, the nanoparticle-based back reflectors may contain various material types, including but not limited to, titanium dioxide, silicon dioxide, zinc oxide, barium titanate and barium sulfate, with sizes ranging from about 25 to about 50 nm, about 50 to about 100 nm, about 100 to about 500 nm, and about 500 to about 1000 nm. In a related aspect, such materials and sizes may be identified by their high refractive indexes, lack of visible light absorption, strong light diffraction and scattering properties. In embodiments, the material type is titanium dioxide and the size is about 410 nm. In a related aspect, quantifying optimal performance properties are disclosed including film thickness, ratio of about 400 nm particles to about 25 nm particles, ratio of anatase TiO₂ to rutile TiO₂ particles, concentration of particles in the above solution, and EPD conditions.

In embodiments, performance properties may be optimized so as to achieve high reflectance by adjustment of supplied voltage and deposition times. In one aspect, film reflectance may be saturated when the film is thicker than about 20 microns. In another aspect, films thicker than about 30 microns are susceptible to cracking and flaking when exposed to mechanical stress.

In another aspect, when the concentration ratio of nanoparticles in solution is below about 1.25 mol/liter, the film does not deposit efficaciously on substrates. In embodiments, dense particle films meeting the performance properties as disclosed herein (e.g., maintaining film thickness) may be deposited at a concentration of about 1.25 to about 1.55 mol/liter, 1.25 to about 1.30 mol/liter, about 1.30 to about 1.35 mol/liter, about 1.35 to about 1.40 mol/liter about 1.40 to about 1.45 mol/liter, about 1.45 to about 1.50 mol/liter, about 1.50 to about 1.55 mol/liter. In embodiments, a back reflector may be placed directly on the intended solar product. In other embodiments, the back reflector may be used as a solar cell back electrode, thus combining the light reflecting and scattering functionality while also being conductive to collecting electrical charges.

When a film is dropped 1 meter above ground, a common test in the small to medium display industry, some particles come free from the film. Even though the majority of the film remains intact, a few loose particles in a cell phone or tablet device could affect image quality and is unacceptable in the market. Thus, various lamination schemes are available and may be applied to the nanoparticle-based films as disclosed herein in order to improve the mechanical durability. Lamination may include, but is not limited to, the use of a parylene spray, clear paint, ethylene-vinyl acetate (EVA) films, and the like, and diffuse reflection characterizations may be repeated to ensure that light reflection and scattering properties are not significantly affected by lamination. FIG. 1 shows a diagram of a final laminated product.

The deposited films as disclosed herein show excellent adhesion to the substrate and are not damaged when handled or rubbed. However, the film can be scratched with a sharp point, in a manner similar to scratching the paint off of an automobile. As stated above, the back reflector may be used as a solar cell back electrode, as such, the resulting product should be able to withstand harsh processing conditions, such a roll-top-roll web handling, high vacuum, high temperatures and high density plasma, including that the reflector must be sufficiently conductive and must have an engineered surface morphology/roughness. Given these requirements, chemically stable and inert materials may be used instead of organic based lamination materials, in that inorganic materials are more suited to withstand harsh processing conditions used in solar cell fabrication.

In embodiments, mechanical durability, conductivity, and small surface roughness may be achieved by using a zinc oxide solution, smaller sized nanoparticles (about 20 to about 25 nm, or <30 nm) along with the larger particles (e.g., about 400 nm to about 415 nm, or about 410 nm), or combinations thereof. While not being bound by theory, mechanical durability may be achieved when a zinc oxide solution penetrates into the pores of the nanoparticle film which then acts as a host matrix binding the nanoparticles together. It will be apparent to one of skill in the art that the solution based transparent conductive oxide (TCO) may be prepared with other materials, including, but not limited to, doped zinc oxide, indium tin oxide, fluorine-doped tin oxide, Ga- or Al-doped tin oxide, poly(3,4-ethylenedioxythiophene), poly(4,4-dioctylcyclopentadithiophene), and the like.

In a related aspect, the zinc oxide solution comprises “active” ingredients (e.g., including, but not limited to, zinc acetate, ethanolamine, and methoxyethanol) dissolved in volatile solvents such that the solution has low viscosity and may coat any surface, with the solvent evaporating, leaving behind a zinc oxide layer. Further, smaller sized nanoparticles can be densely packed into the pores of the larger particles such that contact, and thus Van der Waal's adhesion forces between the particles, is increased. In embodiments, the ZnO solution is a transparent conductive ZnO coating.

In embodiments, the back reflector as disclosed herein may be used directly as the solar cell back electrode, thus combining the light reflecting and scattering functionality with conductivity (i.e., able to collect electrical charges).

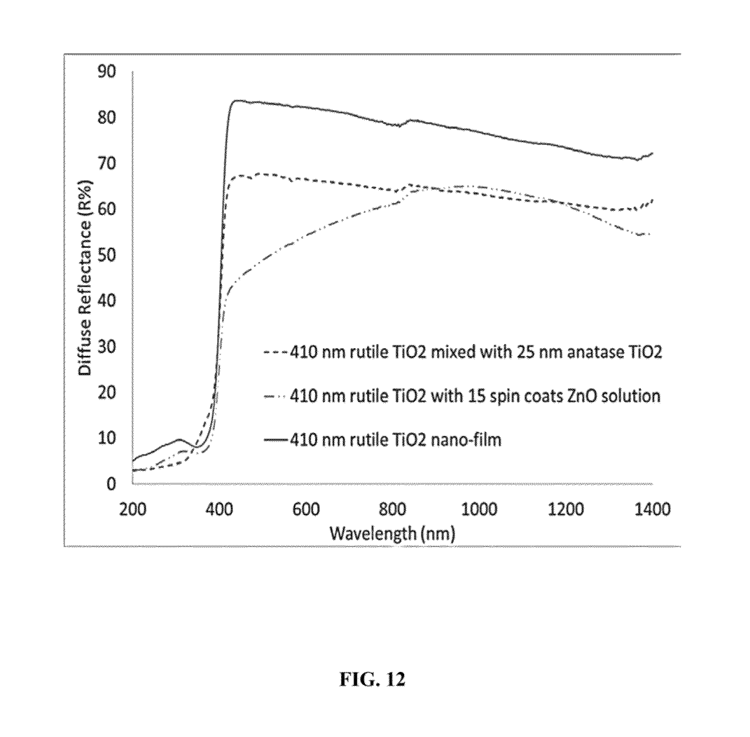

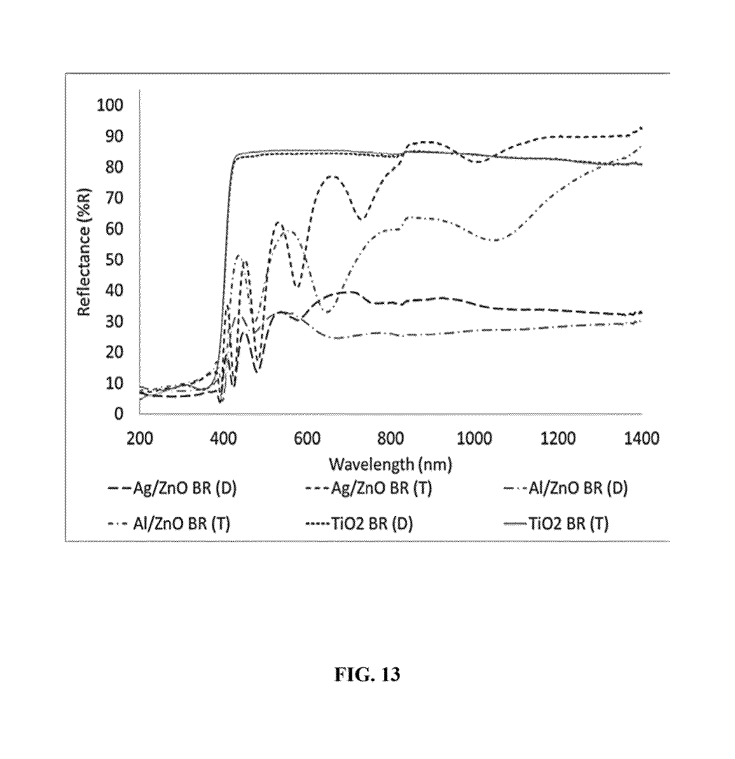

In embodiments, electrical conductivity of the film may be improved using the zinc oxide solution or by using other conductive materials such as anatase TiO₂. The zinc oxide solution may be made conductive by annealing in hydrogen atmosphere. And anatase TiO₂, though slightly less reflective than it rutile counterpart, is conductive and may be deposited directly to the back reflector film or mixed with rutile TiO₂ particles. The back reflector films may have resistivity in the kOhm-cm range and remain sufficiently conductive since electrical charges only need to travel a few microns from the solar absorber material to the metal foil electrode. In a related aspect, conductive hydrogen annealed zinc oxide films spun coated onto large rutile TiO₂ nanoparticle-based films as disclosed herein may exhibit a resistivity lower than 300 ohm-cm. In a further related aspect, similar conductivity is exhibited by anatase TiO₂ particle films prepared by spin coating or EPD as disclosed herein. Changes in diffuse reflection as a function of zinc oxide solution and smaller size particle incorporation may be seen in FIG. 12, which demonstrates that while there is a slight reduction in diffuse reflection using the ZnO solution, diffuse reflection is still higher than that achieved using sputtered metal based back reflectors (FIG. 13).

In embodiments, a suitable surface morphology is necessary so that solar absorber films, such as thin film silicon or cadmium telluride, may be deposited onto the back reflector as disclose herein using conventional processes. While not being bound by theory, large surface roughness leads to strong scattering of light, but may cause non-uniform solar cell active layers, reducing the solar cell efficiency and stability. The surface engineering of the present disclosure overcomes this non-uniformity effect. In a related aspect, a surface roughness of about 50 to about 100 nm may be used, in embodiments, about 55 to about 95 nm, about 60 to about 90) nm, or about 65 to about 85 nm, or about 70 to about 80 nm.

In embodiments, the nanoparticle-based back reflector as disclosed herein may be integrated into a fully operation thin film solar cell (single junction or multi-junction). In one aspect, the back reflector films and solar cells may be fabricated separately, and the back reflector may be place directly behind the semi-transparent solar cell, where such a fabrication method may result in a sub-cell for a triple junction device.

In embodiments, the nanoparticle-based back reflector may be incorporated into a functional multi-junction thin film silicon solar cell, where, for example, the solar cell is placed directly on top of the reflector film of 2 inch by 2 inch size. In a related aspect, the nanoparticle-based back reflector is compatible with standard solar cell processing environments, such as high vacuum, high temperature, and high plasma density environments. In a further related aspect, the use of the nanoparticle-based back reflector as disclosed herein improves the efficiency of such a multi-junction thin film silicon solar cell by about 10%, about 20%, about 30% or about 40% compared to sputtered aluminum and zinc oxide back reflector containing solar cells.

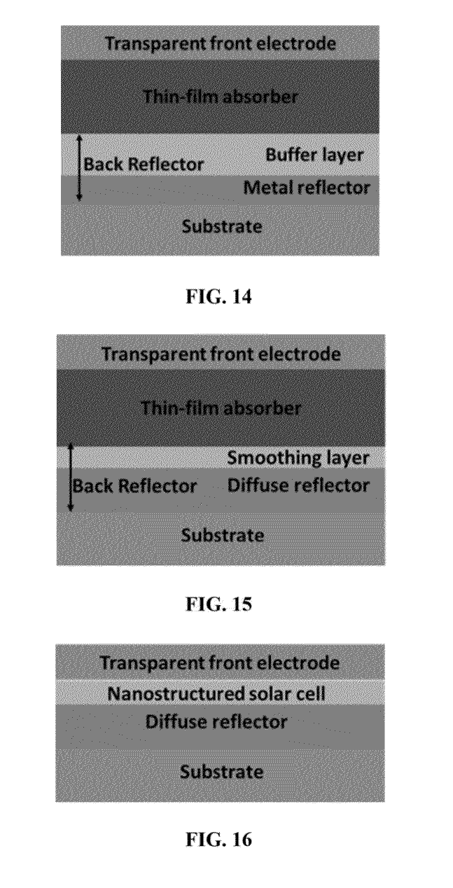

FIG. 14 is of a prior art substrate configured thin film solar cell with conventional reflector. Substrate configured solar cell refers to this deposition sequence: substrate, back reflector, absorber material, transparent front electrode. Alternatively, solar cells can be in superstrate configuration with this deposition sequence: substrate (e.g., glass, plastic, and the like), transparent front electrode, absorber material, back electrode and back reflector (FIG. 15).

In embodiments, the back reflector as disclosed herein becomes a nanostructured “scaffold” for solar absorber materials as shown in FIG. 16. A smoothing layer used in previously described back reflectors becomes a nanostructured “scaffold” for nano-size solar absorbers and charge conducting layer. In the case of a perovskite solar absorber, for example, perovskite material would be deposited directly onto the particles of the smoothing layer and hence be intermixed within the smoothing layer film vs. on top of the smoothing layer film (see FIG. 15). Perovskite acts as both the absorber material and hole transporting material, and particles of the smoothing layer act as electron transporting material.

In the case of dye sensitized solar cells, quantum dot sensitized solar cells, and extremely thin absorber solar cells, the absorbing material and hole transporting material are the same as prior art, but the novel aspect is the use of the back reflector as disclosed and particles of smoothing layer as a nanostructured scaffold and electron transporting material.

In embodiments, the back reflector/nanostructured solar cells as described herein are stamped into various shapes and sizes such as building materials (e.g., aluminum siding) or other appliances. In a related aspect, “coil coating” may be used, where large rolls of metal are treated and/or painted and then are stamped/cut into the desired shapes and sizes which provides scale, cost savings, and processing control compared to painting multiple individual pieces. Similarly, the back reflector/nanostructured solar cells (e.g., perovskite) as disclosed herein may be deposited onto large rolls of metal substrate and stamped into any desired shapes and sizes, such as building integrated materials (e.g., house siding).

As disclosed herein, the morphology and thickness of the deposited film is greatly dependent on applied voltage, deposition time, particle size, nanoparticle concentration, and substrate conductivity. The characteristics of the deposited film can be controlled through the adjustment of supplied voltage and deposition times.

In embodiments, different voltages with different deposition times have been assessed. In one aspect, it was determined that lower voltages with longer deposition times yielded films with higher diffuse reflectance while maintaining good adhesion and uniformity. In embodiments, nanoparticle films may be grown on larger area conductive metal foils.

As disclosed herein, the morphology and thickness of the deposited film is dependent on applied voltage, deposition time, particle size, nanoparticle concentration and substrate conductivity. The characteristics of the deposited nanofilm may be controlled through the adjustment of supplied voltage and deposition time. In embodiments, different applied voltages may be used along with different time durations. In one aspect, higher voltages and longer duration times produce thicker films, with higher diffuse reflectance. In a related aspect, films that were too thick (>about 30 microns) exhibited poor film quality and typically cracked, with pieces of the film coming off of the substrate. In one aspect, film reflectance is saturated when the film is thicker than >about 20 microns.

In other embodiments, post-deposit modifications of the nanoparticle containing films may be carried out, including creation of holes in the nanoparticle (e.g., by electrical discharge, mechanical and thermal stress, or via lithographic methods) and/or through washing the substrate with various solvents, including but not limited to, water, acetone, hexane, isopropyl alcohol, and the like, where such washing does not substantially affect the diffuse reflectance properties of the back reflectors. In embodiments, nanoparticle films with holes or cracks in them may be filled with conductive material and an optional planarizing layer. In one aspect, electrical conductivity may be improved by addition of a heating step. In embodiments, from about 0° C. to about 100° C., about 100° C. to about 200° C., about 200° C. to about 300° C., about 300° C. to about 400° C., about 400° C. to about 500° C., and about 500° C. to about 600° C., for about 15 min. to about 30 min., about 30 min. to about 45 min., about 45 min. to about 60 min. In embodiments, such a film may exhibit resistivity of about 0.4 ohm-meters.

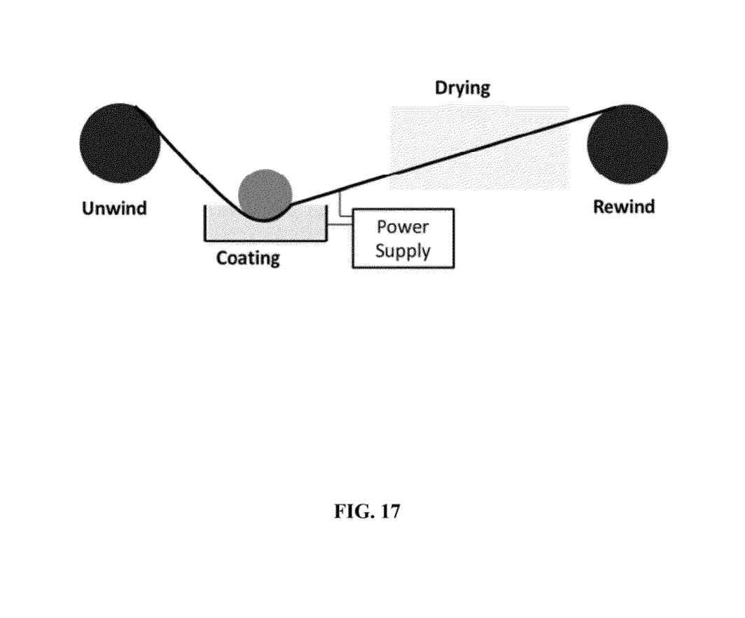

In embodiments, the nanoparticles as described herein may be deposited using a roll-to-roll system. Such a system is shown in FIG. 17. In one aspect, the substrate for the back reflector (i.e., web) may be a magnetic stainless steel foil, which web may be about 0.004 inches thick, about 2 inches wide and about 10 feet long, about 4 inches wide and about 300 feet long, about 3 feet wide and about 1 mile long, although one of skill in the art will recognize that other materials and other dimensions may be used, including that such deposition may be optimized for variables such as mechanical and thermal properties, web speed, applied voltage, deposition time (e.g., duration of foil in EPD bath), drying time, coating bath, roll unwind, roll rewind, as well as various configurations related to dryers, web tracking tension bars and the like.

In embodiments, such systems will be optimized for continuous and jitter-free web tracking. In a related aspect, the system may be monitored along various locations along the web, e.g., at the beginning, middle, and end to determine any changes in film quality, thickness, and diffuse reflectance to ensure product stability. Such systems are available from Xunlight, Corporation (Toledo, Ohio).

Thin film solar cell may be CdTe, CIS or CIGS, or thin film silicon (e.g., tandem, or triple junction configurations using either amorphous Si, micro/nano-crystalline Si, or a combination of both materials).

The highly reflective and light scattering films as disclosed can be used to increase solar cell efficiency when used as the back reflector layer. As stated above, the back reflector layer increases the optical path of light across the absorber material, thus maximizing the opportunity of light absorption and enhancing the efficiency. In embodiments, the highly reflective and light scattering films of the present disclosure may also be used to enhance the back illumination of flat panel displays, liquid crystal displays (LCDs), specifically the edge-illuminated LCD designs. For both solar cell and LCD applications, the reflector of the instant disclosure provide superior reflection and light scattering at lower costs compared to the current state of the art.

In one aspect, LEDs can replace fluorescent lamps as the backlight source for small LCDs such as cell phones, hand held devices, medical monitors and automotive displays. The advantage of using LEDs is their low price, small size and low energy consumption. The disadvantage of LEDs is their relatively low brightness. With the use of a diffuse reflector as a back reflector along with known specular reflective film layers, the brightness of LED (or organic LED [OLED]) displays can be increased.

In embodiments, the nanoparticle-based back reflectors as disclosed may be used to fabricate LED or OLED-containing devices such as television screens, computer monitors, and portable systems such as mobile phones, handheld games consoles and PDAs.

The methods, solutions, nanoparticle films and coatings will be understood more readily by reference to the following examples, which are provided by way of illustration and are not intended to be limiting.

### EXAMPLES

### Example 1

### BaTiO₃ Nanoparticle Films

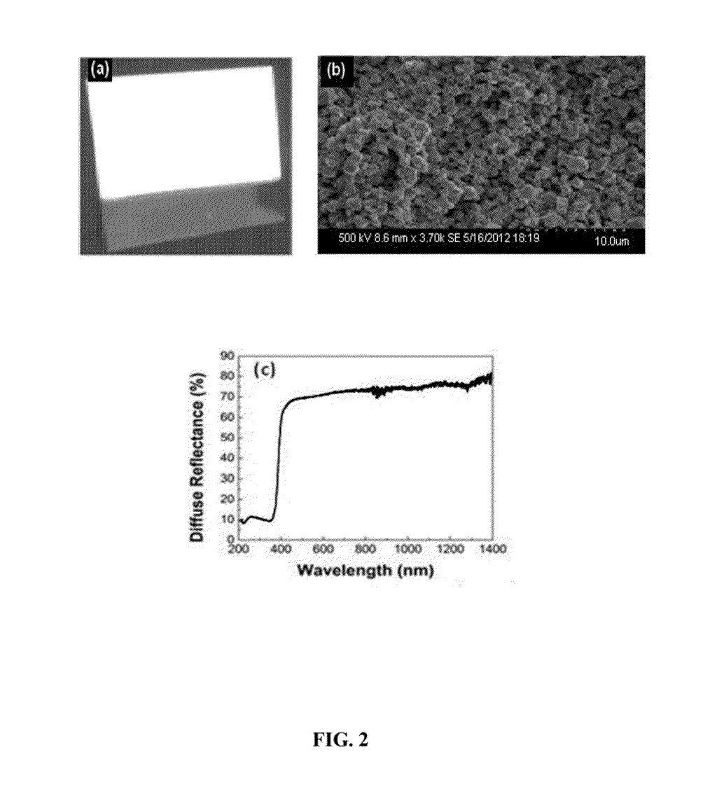

BaTiO₃ nanoparticles were deposited onto either ITO coated glass substrates, silicon wafer (doped and undoped) substrates, or aluminum substrates using the apparatus shown in FIG. 1. Solutions comprising BaTiO₃ nanoparticles (average diameter ˜700 nm) were prepared by adding 7.5 g BaTiO: nanoparticles to 150 mL of Blend A. Prior to electrophoretic deposition, the solutions were sonicated for about 5 to 30 min. Films of BaTiO₃ nanoparticles were deposited onto the various substrates via electrophoretic deposition under the following conditions: a direct voltage of 60 V; a distance of 2 to 4 cm between the electrode (either Pt foil, ITO coated glass, or aluminum) and substrate; deposition times of 5 min; and deposition temperature of room temperature. Finally, the nanoparticle films were evaluated using standard techniques. The nanoparticle films were about 20 μm thick and exhibited a surface roughness in the range of from about 100 nm to about 3 μm. The photograph image of a film shown in FIG. 2A revealed that the film was well adhered to the substrate and was of uniform thickness. A substantially continuous film was formed across the entire surface of the substrate with substantially no cracking and substantially no rippling, even at the edges of the substrate. The SEM image of the film shown in FIG. 2B revealed that the nanoparticles in the film were densely-packed and the film was textured. The diffuse reflectance spectrum of the film shown in FIG. 2C revealed that the film was highly reflective over a broad range of visible wavelengths. These experimental results confirm that the deposited nanoparticle film is suitable for use as a back reflector in a solar cell.

### Example 2

### Ag Nanoparticle Films

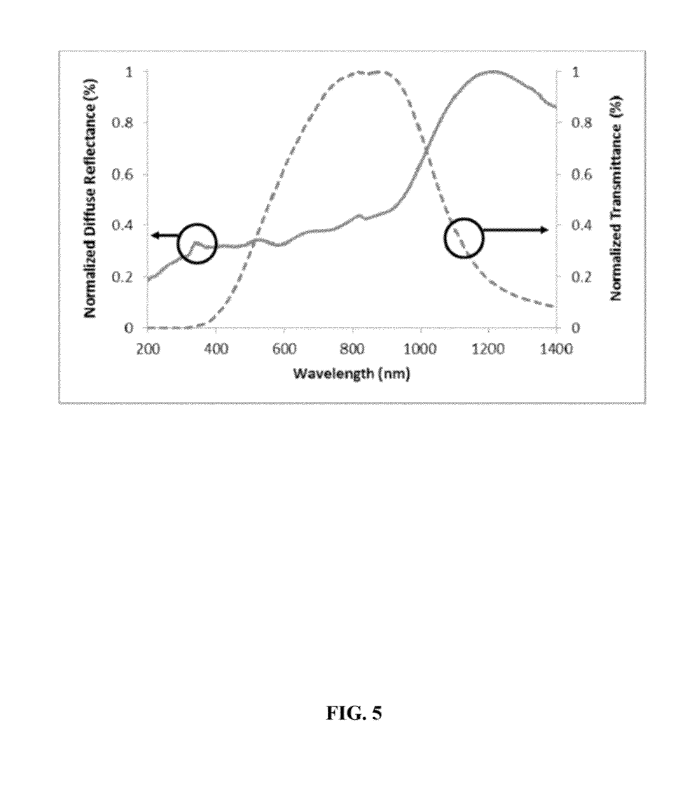

Ag nanoparticles were deposited onto ITO coated glass substrates using the apparatus shown in FIG. 1. Solutions comprising Ag nanoparticles (average diameter ˜50-80 nm) were prepared by adding 0.1 g Ag nanoparticles to 100 mL of Blend A. Prior to electrophoretic deposition, the solutions were sonicated for about 20 min. Films of Ag nanoparticles were deposited onto the substrates via electrophoretic deposition under the following conditions: a direct voltage of 60 V; a distance of 2 to 4 cm between the electrode (Pt foil) and substrate; and deposition times of 1 to 5 min. The normalized diffuse reflectance and transmission spectra of the film shown in FIG. 5 revealed that the film transmits visible wavelengths of light and reflects both UV and infrared wavelengths of light. These experimental results confirm that the deposited nanoparticle film is suitable for use as a low emissivity coating for a glass window.

### Example 3

### Si Nanoparticle Films

Si nanoparticles were deposited onto ITO coated glass substrates using the apparatus shown in FIG. 1. Solutions comprising Si nanoparticles (American Elements, average diameter ˜130 nm) were prepared by adding 0.1 g Si nanoparticles to 40) mL of Blend A. Prior to electrophoretic deposition, the solutions were sonicated for about 20 min. Films of Si nanoparticles were deposited onto the substrates via electrophoretic deposition under the following conditions: a direct voltage of 5 to 60 V; a distance of 2 to 4 cm between the electrode (Pt foil or ITO coated glass) and substrate; and deposition times of 20 s to 6 min.

### Example 4

### Method of Producing Film Using TiO₂ Nanoparticles

HNO₃ based spin on glass solution (AR/LR-800) from Industrial Science and Technology Network, Inc & Dupont R-900 410 nm TiO₂ particles were added in a 10 mL:1 g ratio. The solution was stirred vigorously and sonicated for 8 minutes. Continuous agitation with a magnetic stir bar in between depositions was observed to prolong the life of the solution from day to day.

The solution was centrifuged at 3000 RPM for 3 minutes to remove agglomerations and the centrifuged solution was decanted into the electrophoretic deposition bath container. Deposition onto the desired substrate, e.g., aluminum, stainless steel piece of metal or foil, was carried out at 200V for 20 s, for thickness of about 20 microns. This removed larger agglomerations of particles, resulting in depositing a smaller distribution of particle sizes for smoother and more conformal morphology as seen by SEM. Further, the larger agglomerations were observed to more easily fall off of the film which, while not being bound by theory, may cause short circuits and prevent the operation of, for example, a solar cell when depositing solar cell layers directly onto nanoparticle film as disclosed herein.

HCl based spin-on-glass solution from ISTN which seemed to cause stainless steel substrates to rust; HNO₃ solution has not shown rust to date, with all other aspects of performance remaining the same.

The above were determined to be optimal conditions in order to minimize time and maximize film adhesion, where films with greater thickness began to split in half along the horizontal axis. Further, the diffuse reflection was essentially maximized at approx. 20 micron thickness, where doubling the thickness only increased the reflectance by a few % points, however, this was accompanied by deterioration of mechanical properties.

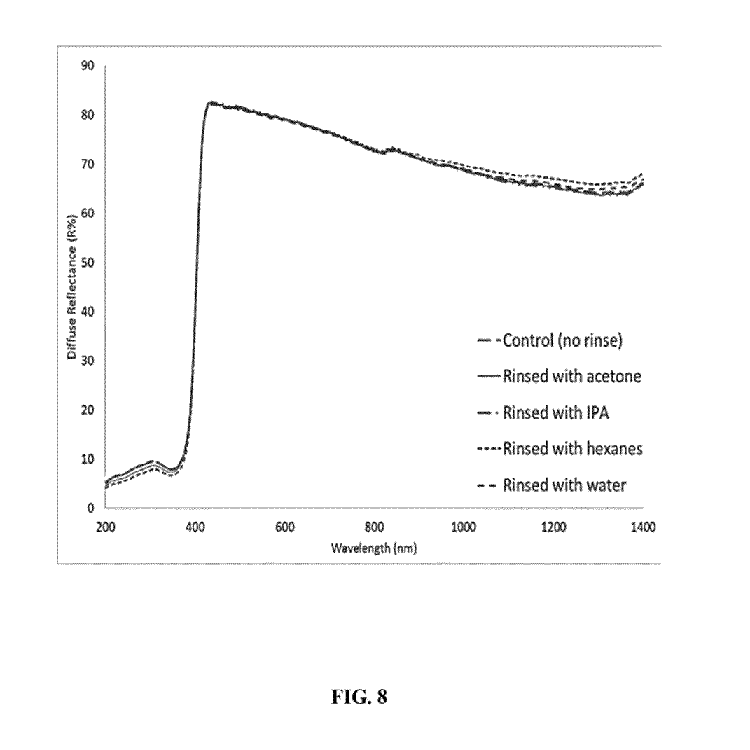

Samples of R-900 (TiO₂) coated substrate were subjected to post-deposit washings using various solvents including acetone, hexane, isopropyl alcohol and DI water, where diffuse reflectance was determined post-treatment (FIG. 8). As can be seen from the figure, diffuse reflection is essentially the same (1-2% difference) for the nanoparticle films (20 second deposition at 200V to achieve about a 20 micro thickness) for all rinses. As such, the reflection properties of the films are independent from the components in the solution (e.g., water, acid, organic components, and dopants).

### Example 5

### Method of Producing Film Using BaSO₄ Particles

1 g of BaSO₄ nanoparticles from Wako was added to 3.42 mL of SOG solution (e.g., HNO₃ as in Example 4); vigorously stirred and sonicated for 8 minutes; centrifuged at 3000 rpm for 3 minutes and decanted into electrophoretic deposition bath container; where after 50V was applied for 3 minutes.

### Example 6

### ITO Coating of TiO₂ Film

To the HNO₃-based Spin-on-Glass (SOG) from ISTN, ITO particles from US Research & Nanomaterials (20-70 nm) were added in a 10 ml:1 g (ITO) ratio. The solution was stirred vigorously and sonicated for about 8 minutes. The solution was then centrifuged at 3000 rpm for 3 minutes to remove agglomerations. The centrifuged solution was then transferred to an EPD bath container.

The ITO was coated onto the R-900 (TiO₂) coated substrate @ 100V for 5 s to achieve about 1 micron thickness.

### Example 7

### Electrical Discharge to Produce Holes on Film Surfaces

Electrical discharge was created between two asymmetrical electrodes. One electrode was a metal (e.g., aluminum) plate of approximately 2 inches by 2 inches with 0.25 inch thickness. The other electrode was a thin wire with approximate diameter of 0.003 inch (i.e., 40 gauge wire). There was approximately 0.5 inch of separation between the electrodes. The conductive substrate with nanoparticle coating was placed directly on the metal plate electrode and was in electrical communication together, connected to ground (alternatively, the nanoparticle coated substrate may be directly connected to ground). Negative 10 kV was applied to the thin wire. The discharge was carried out in air, at room temperature. When the high voltage was applied there was a dielectric breakdown of air creating a spark between the thin wire and nanoparticle film substrate and thus to the metal plate.

The electrical discharge creates a hole in the nanoparticle film all the way to the underlying substrate where the discharge strikes the surface. There are multiple discharges across the length of where the thin wire and metal block overlapped. In comparison, if a sharp point is used instead of a thin wire then essentially only one discharge path is observed. The underlying metal substrate melts and often splashes up the sides of the hole and even on top of the nanoparticle layer surrounding the hole (see FIG. 6b). For a TiO₂ nanoparticle film (see Example 4) the hole diameter and shape changes with discharge time. For example, the approximate size increases from 25-30 microns, 50-70 microns, and 100 microns with 1 second, 5 seconds, and 15 seconds of electrical discharge, that is the time that the high voltage was turned on. The shape was circular at 1 second discharge time and the shape elongates in 1 or more directions as time increases.

Creating holes across the entire area of the nanoparticle film may be accomplished by moving either the thin wire across the length of the nanoparticle film or by moving the nanoparticle film past the thin wire. Typically the nanoparticle coated substrate is placed on the metal plate electrode and the thin wire is off to the side such that thin wire is not over the metal plate, the high voltage is turned on but no electrical discharge occurs, and then the metal plate is moved under the thin wire at an approximate rate of 0.5 inch per second so that electrical discharge effectively occurs across the entire area of the nanoparticle film until the metal plate completely passes from under the thin wire at which point the electrical discharge stops. This results in holes being formed across the entire nanoparticle film area with asymmetrical distribution (see FIG. 6a) with approximately 1˜2 mm spacing.

The holes in the nanoparticle film may then be filled with another material. The holes may be filled with a more conductive material to electrically connect any layers subsequently deposited on top of the nanoparticle film to the underlying substrate. For example, the holes in a TiO₂ nanoparticle film (see Example 6) can be filled with indium tin oxide (ITO) nanoparticles with diameter of 20 nm to 70 nm (see, e.g., FIG. 7). Additionally, the films may be heated at 550° C. for 30 minutes. Such a film exhibits resistivity of approximately 0.4 ohm-meters.

### Example 8

### EPD Deposition of Dielectric Nanoparticles onto an Aluminum Substrate

Solutions comprising dielectric nanoparticles were prepared by adding various amounts of nanoparticles (2 to 10 g) to a commercial spin-on-glass (SOG) solution containing polysiloxane, isopropyl alcohol, ethyl alcohol, ethylene glycol butyl ether, water and hydrochloric acid (20 to 30 ml). Two aluminum electrodes, serving as an anode and a cathode, were held by alligator clips connected to a power supply. Prior to using the substrates (i.e., 1″×0.5″ aluminum substrates), they were thoroughly rinsed with distilled water and acetone, sonicated with both individually, and then dried at room temperature. An EPD bath was prepared by mixing the nanoparticle powder and a solution containing polysiloxane, isopropyl alcohol, ethyl alcohol, ethylene glycol butyl ether, water and hydrochloric acid in fixed ratios. The bath was placed into an ultrasonicator to mix the solution properly. This process was carried out in a beaker sealed with parafilm in order to minimize solution contact with the atmosphere for long periods of time.

When the solution was prepared, the substrates were dipped in the solution. The EPD process was conducted at different voltage levels (50V, 80V, 120V) and deposition times (3 min, 6 min. 10 min, and 15 min). Voltage and time were changed alternatively to observe changes to the film quality. Between depositions, the beaker was sealed with parafilm and the solution was stirred in an ultrasonicator to ensure proper suspension of particles.

Deposition data for various nanoparticle material types and sizes are shown in Table 2.

TABLE 2
Types, Sizes and Manufacturing Companies of Different Nanoparticles.

| Nanoparticle Material | Size (nm) | Types | Manufacturing Company |
|---|---|---|---|
| Titanium Dioxide (TiO₂) | 30 | Rutile 99.9% | US Research Nanomaterials |
| | 165 | Rutile 99.99% | US Research Nanomaterials |
| | 390 | TS 6200, Select | Dupont Titanium Tech |
| | 410 | R900, Pure | Dupont Titanium Tech |
| | 1000~2000 | Runk 99.5% | Alfa Aesar |
| Barium Titanate (BaTiO₃) | 700 | 5622-ON7 | Inframat Advanced Materials |
| Zinc Oxide (ZnO) | 35~45 | US3556 99+% | US Research Nanomaterials |
| | 80~200 | US3555 99.9% | US Research Nanomaterials |
| Silicon Dioxide (SiO₂) | 20~60 | 6810 DL | Sky Spring Nanomaterials |
| | 0.5 | L16985 99% | Alfa Aesar |
| | 1 | L16986 99% | Alfa Aesar |
| | 1.5 | L16987 99.9% | Alfa Aesar |
| Barium Sulfate (BaSO₄) | 2400~4800 | Cat. No. 022-00425, | Wako |
| | | Lot-WEL4563, SG: | |
| | | 4.5 | |

Multiple material types and sizes were deposited in order to determine which was suitable for light reflection and scattering applications and sufficiently deposited into thick and uniform films. The nanoparticle material types were chosen due to their commercial availability, chemical stability, and pre-existing use in solar cells. In addition to titanium dioxide (TiO₂), silicon dioxide (SiO₂), and zinc oxide (ZnO), nanoparticle-based films using barium titanate (BaTiO₃) and barium sulfate (BaSO₄) were also prepared, given these materials have high refractive indexes and are currently being used in spectrophotometers for their light reflection and scattering properties.

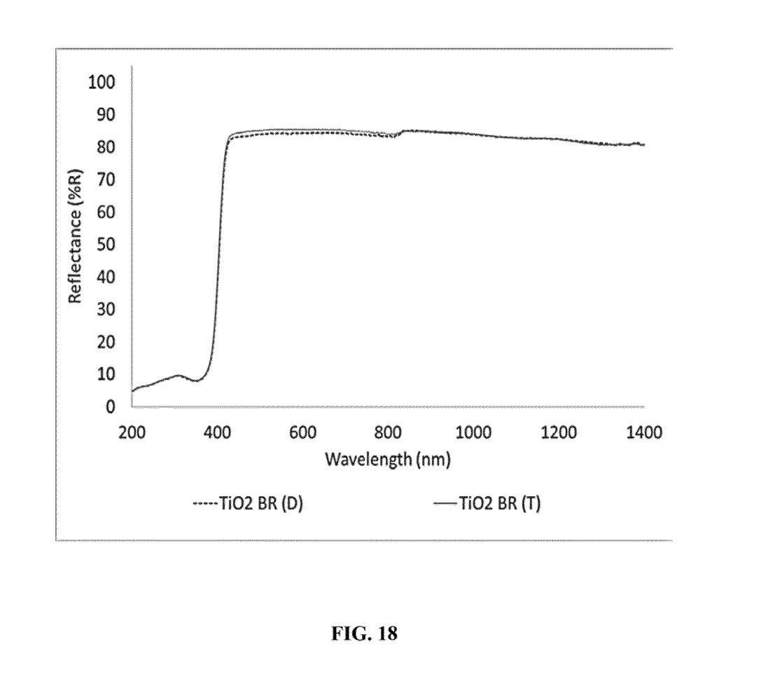

The light reflection and scattering capabilities of the nanoparticle-based films were characterized using a UV-Vis spectrophotometer over a broad spectrum of ultraviolet (UV), visible, and infrared (IR) wavelengths (200 nm to 1400 nm) using a BaSO₄ reference standard. FIG. 18 shows the measured total and diffuse (i.e., scattered) reflectance of a TiO₂ nanoparticle-based film.

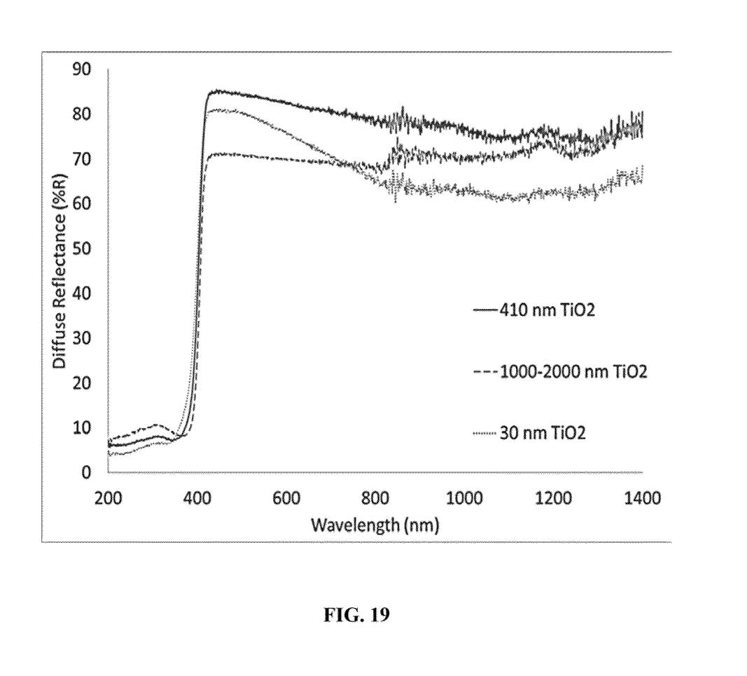

The total and diffuse reflection curves are shown to be overlapping. Thus, all of the light reflected from the nanoparticle-based films is scattered, which is one of the competitive advantages of the product compared to other films available, which exhibit specular (i.e., mirror-like) reflection. FIG. 19 shows the effects that nanoparticle size has on the diffuse reflection for TiO₂ nanoparticle-based films. 410 nm sized particles had relatively flat reflection across visible and IR regions (400 nm to 1400 nm) at approximately 88%. In comparison, 30 nm sized particles had the highest reflection of ˜82% at the edge of UV-visible (400 nm) and dropped to ˜62% reflection in the IR region. The 1000-2000 nm sized particles had a reflection spectrum somewhere between 410 nm and 30 nm particles, with reflection drop off across the visible and IR regions not as severe (˜80% to ˜72%), higher reflection in red and IR regions (600 nm to 1400 nm), but lower reflection in visible region (400 nm to 600 nm). Therefore, the ability to reflect and scatter light is dependent on the size of the nanoparticles, where the 410 nm sized particles clearly had the best diffusion reflection properties (FIG. 19).

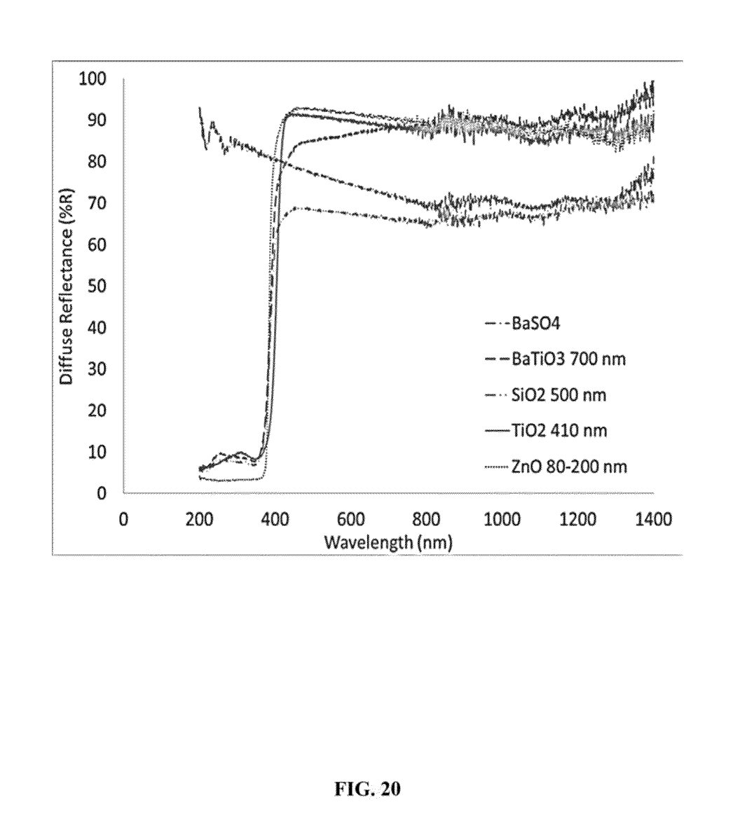

FIG. 20 shows the diffuse reflectance of the best nanoparticle-based films for the various material types and sizes. All of the nanoparticle materials, except BaSO₄, showed absorption in the UV region (200 nm to 400 nm) and high reflection in the visible and IR regions (400 nm to 1400 nm). BaSO₄ nanoparticle-based films showed reflection across UV-Vis-IR spectrum. These BaSO₄ films should have had 100% diffuse reflection since it has the same material as the reference standard, however, sufficiently thick and uniform nanoparticle-based films could not be deposited, which may explain the less than 100% reflection. BaTiO₃, TiO₂ and ZnO had the highest reflectivity to date, with 80-90% reflection over visible and IR regions. BaTiO₃ diffuse reflectance was greatest among all films in the IR range (˜90-95%). TiO₂ Titanium-pure (R900) showed a relatively even amount of reflectance (˜90%) across visible and IR wavelengths. ZnO (80-200 nm) was the third most reflective overall. However, the reproducibility of depositing ZnO nanoparticle-based films was very poor where typically no film was able to be deposited. SiO₂ films exhibited poor reflectance (˜65%) while also having poor film thickness and uniformity. While not being bound by theory, it may be that the nanoparticle materials that were unable to deposit into thick films possess shapes and/or present surface chemistry which interact differently with the EPD solutions.

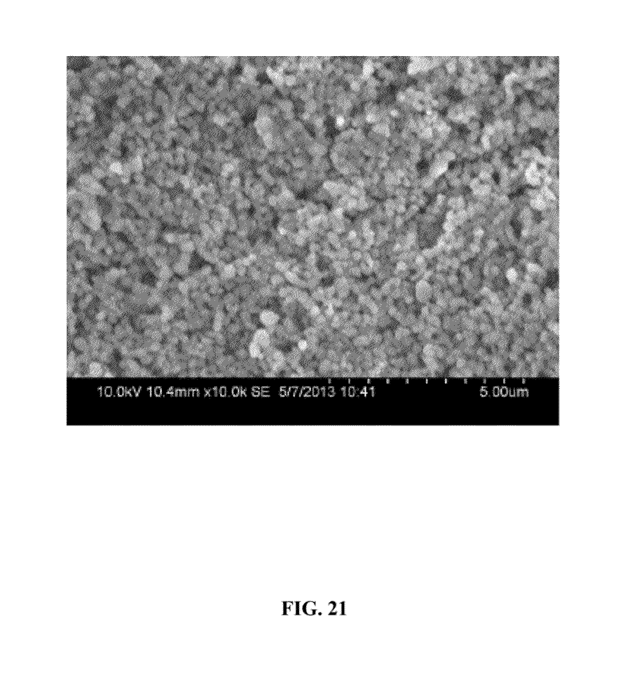

Dupont TiO₂ products (˜400 nm) were determined to be the best material selection based on deposition uniformity, thickness, repeatability, diffuse reflection, and low cost. FIG. 21 shows a typical scanning electron microscope (SEM) image of 410 nm TiO₂ nanoparticle-based back reflector film. A highly packing density of nanoparticles is demonstrated, which is critical for strong cohesion to form high quality films. Further, a higher density of particles creates more high (particle)/low (air) refractive index interfaces, thus promoting high light reflection and scattering via numerous light diffractions.

In summary, various materials and sizes have been identified for nanoparticle-based back reflector films, where such films exhibit high uniformity, strong cohesion and adhesion at sufficient thicknesses, resulting in products with high light reflection and scattering properties. Different nanoparticle material types with varying sizes were deposited into films by EPD and nanoparticles comprising TiO₂ at about 400 nm had the best performance properties. The TiO₂ nanoparticle films exhibited good adhesion quality over the entire substrate, and showed 80-90% diffuse reflectance, with strong scattering effects, resulting in the largest photocurrent and efficiency improvements for a thin film solar cell compared to metal sputtered based back reflectors, where the latter exhibited 25-35% diffuse reflectance. These observations are robust and reproducible, such that the films exhibit similar diffuse reflectance spectra as well as share similar visual thickness and uniformity of deposition.

### Example 9

### Nanofilm Stability

The nanoparticle back reflector films were subjected to stability and lifetime tests by simulating the effect of heating and cooling cycles as well as other manufacturing and environmental stressors.

The nanoparticle films were heated on a hot plate and in an oven up to temperatures of 500° C. and allowed to cool back to room temperature without observing any effect on film quality or color change after visual inspection and reflectance measurements.

Film strength and adhesion was tested by scratching the film with a diamond scriber and then firmly pressing adhesive tape to the surface and, with the exception of particles loss around the outside and scratched edges, essentially none of the nanoparticle-based film was removed; i.e., overall film remained intact on the surface.

To further test mechanical durability, compressed air was also blown directly onto the nanoparticle film and from the side across the film, and no damage to the film was detected. These tests demonstrate that the film exhibits strong cohesion and adhesion to substrate.

### Example 10

### Comparison Between Nanoparticle-Based Back Reflector with Metal Sputtered Ag/ZnO and Al/ZnO Back Reflectors

The light reflecting and scattering performance of the nanoparticle-based films were compared to state-of-the-art metal sputtered Al/ZnO and Ag/ZnO back reflector technologies and the effects that they had on a semi-transparent thin film silicon solar cell (FIG. 13). The dielectric nanoparticle-based back reflector films demonstrated ˜85% light reflection and strong scattering properties compared to Al/ZnO (˜25%) and Ag/ZnO (˜35%) back reflectors, which resulted in the largest photocurrent improvement.

The total diffuse reflectance of the nanoparticle-based back reflector were shown to overlap, such that the total reflectance was all diffuse reflectance and was higher than both metal sputtered Al/ZnO and Ag/ZnO back reflectors. The sputtered metal based reflectors were not very light scattering and were more specular as shown by their higher total vs. diffuse reflectance.

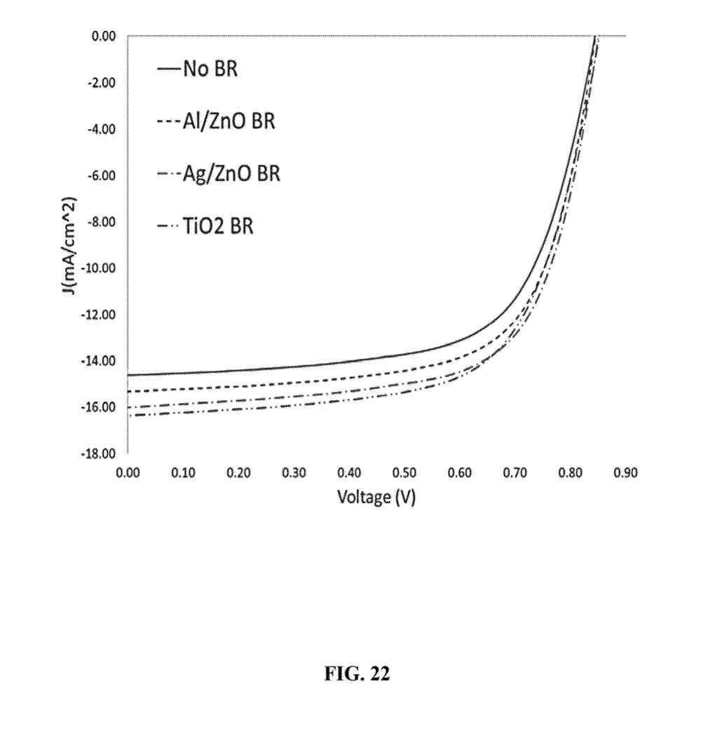

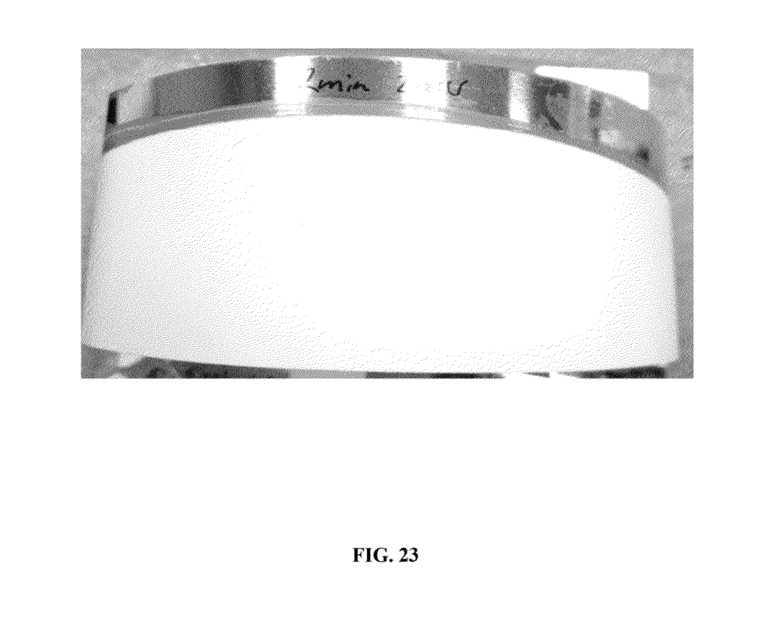

FIG. 22 shows the current-voltage response produced by a National Renewable Energy Laboratory (NREL) thin film silicon solar cell using the nanoparticle-based back reflector compared to the metal sputtered Al/ZnO and Ag/ZnO back reflectors. The back reflectors were prepared separately and were place directly behind the solar cell for measurement. The effect of the back reflector on the solar cell performance is directly correlated to the photocurrent since more absorbed photons, i.e., light, results in more electron-hole pairs being generated, thus greater photocurrent and an increase in the solar cell efficiency. Data from IV measurements may be seen in Table 3.

TABLE 3
IV Performance Data for Nanaoparticles vs. Al/ZnO and Ag/ZnO.

| | Jsc | | | Efficiency | |
|---|---|---|---|---|---|
| | (mA/cm²) | Voc (V) | FF (%) | (%) | % Change |
| No BR | 14.61 | 0.845 | 0.658 | 8.123 | |
| Al/ZnO | 15.324 | 0.846 | 0.671 | 8.699 | 7.086 |
| Ag/ZnO | 16.01 | 0.851 | 0.667 | 9.088 | 11.870 |
| Nanoparticle BR | 16.37 | 0.853 | 0.651 | 9.090 | 11.904 |

The metal sputtered Al/ZnO and Ag/ZnO back reflectors used in the production of commercial products resulted in modest photocurrent improvement and efficiency enhancement compared to those without any back reflector. However, while the use of the Ag/ZnO back reflector produced an even large current and efficiency enhancement, due to the chemical instability and shortened product lifetime, it cannot be used in commercial products. In comparison, the nanoparticle-based back reflector produced higher photocurrent and efficiency compared to the Ag/ZnO back reflector.

While not being bound by theory, additional efficiency advantages seem to come from the high reflectance over a broad spectrum (400 to 1400 nm, blue to infrared) of the nanoparticle-based reflector versus Al back reflectors that have relatively poor reflection in the long wavelength range of 700-1000 nm, which is critical for efficient enhancement due to the low absorption coefficient of the solar cell absorber layer. Therefore, for triple-junction thin film silicon solar cells significantly more efficiency improvement will be afforded by the nanoparticle-based back reflectors.

### Example 11

### Use of Nanoparticle-Based Back Reflector Films with Foils

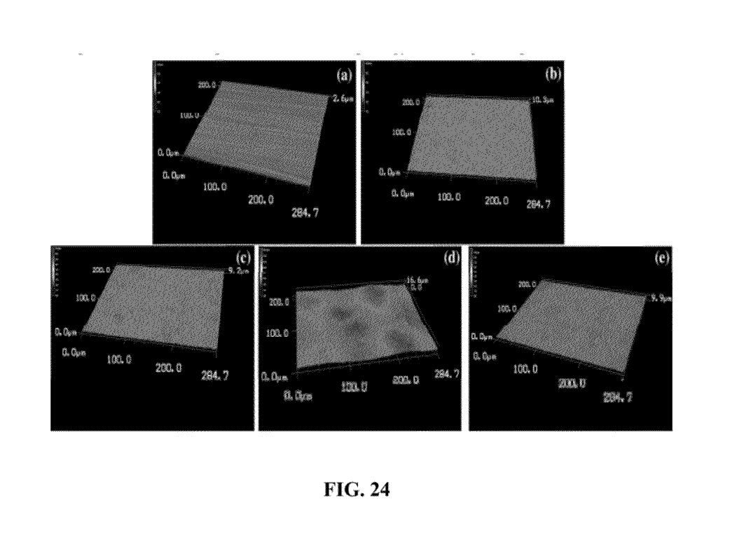

Nanoparticle back reflector films were deposited onto 2 inch by 8 inch stainless steel foils as illustrated in FIG. 23. Depositing on metal foils allows for more efficient deposition on large scale and allows for custom sizing for utilization in different applications.

The analysis was performed by rolling the steel substrate up in a hoop configuration around a standard glass beaker, held together with a zip-tie, and submerged 1 inch into a stainless steel beaker containing the nanoparticle suspension. The stainless steel foil substrate and beaker remained isolated from each other and did not come into contact. Further, mechanical durability was tested by bending the stainless steel foil substrate, where the nanoparticle-based back reflector was shown to be resistant to such torsional stress.

### Example 12

### Surface Morphology

Sufficiently small surface morphology is crucial so that solar absorber films, such as thin film silicon or cadmium telluride, may be deposited onto the nanoparticle-based back reflector using conventional processes. Too large a surface roughness can create defects in the solar absorber layer, which reduces the lifetime of the solar product. A surface roughness of approximately 50 nm or less was found to be useful, and was used in further analyses.

It was observed that 2 to 6 grams of particles in 30 mL solution resulted in films with rougher surfaces. Also, the use 8 to 10 grams of particles in 30 mL of solution resulted in films with smoother surfaces, but with some micro-sized cracks.

### Example 13

### Drying Conditions and Surface Morphology

The effect of drying conditions on the surface morphology was performed using a color 3-D laser scanner, the scans of which are shown in FIG. 24. Vertical and horizontal air drying, as well as heated air drying from a hair dryer, did not have a significant effect on the surface morphology as there were randomly and relatively evenly distributed high and low regions of small size. However, heating the back reflector on a hot plate had a significant effect on the macro-morphology, showing very distinct high and low regions of larger size. While not being bound by theory, this observation may be due to the capillary effect of the nanoparticles being pulled together forming larger “clumps” with quick evaporation of the solvents. This macro texturing produced by heating the nanoparticle films showed slightly higher diffuse reflectance in the visible region compared to other air dried films. However, the nano-scale surface was still relatively large since particles with 400 nm average diameter were used. The surface roughness can further be reduced by using either the zinc oxide solution method or the smaller nanoparticles (<30 nm) to fill the pores and modify the surface morphology of the large nanoparticle based film.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of forming a nanoparticle film comprising:
exposing first and second substrate each connected to an electrode, thereby forming a cathode and anode substrate, to a solution, wherein the solution comprises:
substantially dispersed nanoparticles;
an organic solvent;
a polysilicate;
optionally water; and
optionally one or more of an acid and a dopant; and
applying a sufficient electric field across the electrodes for a sufficient period of time to deposit a nanoparticle film onto an electrode connected substrate and optionally rinsing said deposited material with a second solvent selected from the group consisting of acetone, hexane, water, isopropyl alcohol, and combinations thereof.

2. The method of claim 1, wherein the nanoparticles are selected from the group consisting of SiO₂ nanoparticles, TiO₂ nanoparticles, ZnO nanoparticles, BaTiO₃ nanoparticles, Ag nanoparticles, Au nanoparticles, Al nanoparticles, Si nanoparticles, BaSO₄ nanoparticles, VO₂ nanoparticles, carbon nanoparticles, quantum dots, and combinations thereof.

3. The method of claim 1, further comprising adding a planarizing layer on at least one surface of said nanoparticle film by sol-gel, sputtering, electroplating, or evaporation, and wherein said planarizing layer comprises nanoparticles that are a different size compared to said dispersed nanoparticles.

4. The method of claim 1, wherein the polymer is selected from the group consisting of a polysiloxane, a polysilsesquioxane, and combinations thereof.

5. The method of claim 1, wherein the organic solvent is selected from the group consisting of acetone, ethyl alcohol, isopropyl alcohol, n-butyl alcohol, ethyl lactate, ethylene glycol butyl ether and combinations thereof, and wherein said acid is HCl or HNO₃.

6. The method of claim 1, further comprising heating said nanoparticle from about 0° C. to about 60° C. for about 30 mins, to about 60 mins.

7. A diffuse reflector produced by the method of claim 1, wherein said nanoparticles exhibit high refractive index and possesses a bandgap such that the nanoparticles do not absorb visible and/or infrared light.

8. The diffuse reflector of claim 7, wherein said nanoparticle film contains holes generated by a method selected from the group consisting of electrical discharge, poking, scratching, thermal methods, and lithographic methods.

9. The diffuse reflector of claim 8, wherein said nanoparticle film comprises conductive nanoparticles in said holes.

10. The diffuse reflector of claim 7, wherein said diffuse reflector is a component in a device selected from the group consisting of a photovoltaic solar device, and thermo solar device, a thermoelectric device, a UV reflective device, a display, and a lighting device.

11. A method for modifying a nanoparticle film comprising:
attaching a first electrode in electrical communication with a power supply to a conductive substrate comprising said nanoparticle film;
connecting a second electrode to said power supply, wherein a gap is formed between said first and second electrodes; and
applying an electric field between said first and second electrodes, whereby the applied electric field causes dielectric breakdown which creates holes in the nanoparticle film.

12. The method of claim 11, wherein the first and second electrodes are asymmetric with respect to area.

13. A conductive diffuse reflector comprising:
a first layer comprising a light reflecting and scattering layer containing a first plurality of nanoparticles having a diameter between about 0.1 to about 1.0 μm, wherein said first layer is about 1 to about 50 μm thick, and wherein said first layer optionally comprises holes generated by a method selected from the group consisting of electrical discharge, poking, scratching, thermal methods, and lithographic methods; and
a second layer comprising a smoothing layer containing a second plurality of nanoparticles having a diameter of about 1 to 100 nm, wherein the thickness of the second layer is about 0.1 to about 2 μm.

14. The reflector of claim 13, wherein the first plurality of nanoparticles comprises a dielectric, non-absorbing material selected from the group consisting of TiO₂, ZnO, BaSO₄, SiO₂, and BaTiO₃, and wherein the second plurality of nanoparticles comprises a conductive material.

15. The reflector of claim 14, wherein the conductive material comprises a transparent conducting oxide (TCO).

16. The reflector of claim 13, further comprising a planarizing layer.

17. A method of forming a nanoparticle film on a substrate comprising:
exposing a substrate to a solution, wherein the solution comprises:
substantially dispersed nanoparticles;
a first organic solvent; and
a polymer characterized by a backbone comprising Si—O groups; and
depositing said nanoparticles on said substrate by a method selected from the group consisting of applying an electric field to the solution, dip, spin, spray, roll and curtain coating, and printing methods,
whereby a nanoparticle film is deposited on the substrate.

18. The method of claim 17, further comprising curing said nanoparticle film by UV or thermal radiation.

19. The method of claim 17, wherein the nanoparticle film is applied to a glass substrate, thereby resulting in low emissivity glass.

20. The method of claim 19, wherein the nanoparticles comprise quantum dots.
